(19) United States
(12) Patent Application Publication
(10) Pub. No.: US 2008/0213017 A1
(43) Pub. Date: Sep. 4, 2008

(54) POST-PROCESSING APPARATUS

(75) Inventors: Shigeki MORISAWA, Suzuka-shi (JP); Katsumi TANAKA, Suzuka-shi (JP); Takafumi TANAKA, Suzuka-shi (JP); Takahiro YAMAZAKI, Suzuka-shi (JP); Daisuke ITO, Suzuka-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/028,911

(22) Filed: Feb. 11, 2008

(30) Foreign Application Priority Data
Mar. 1, 2007 (JP) 2007-051943

(51) Int. Cl. G03G 15/00

(52) U.S. Cl. 399/405

(57) ABSTRACT

A post-processing apparatus includes: a compile tray; a post-processing member; a stacker tray; a sheet conveying path including a discharging path, a waiting path and a discharging-path switching member; a sheet conveying member; an one-end alignment medium conveying member; a discharging member; and a discharging-member controlling section.

### CROSS-REFERENCE TO RELATED APPLICATIONS

This application is based on and claims priority under 35 USC 119 from Japanese Patent Application No. 2007-51943 filed on Mar. 1, 2007.

### BACKGROUND

1. Technical Field

The present invention relates to a post-processing apparatus for performing alignment of recording sheets on which an image is recorded, a staple work, and the like, and more particularly, to a post-processing apparatus comprising a sheet end aligning member for conveying (pulling) a recording sheet to a sheet end positioning portion which aligns end edges of recording sheets conveyed to a compile tray.

2. Related Art

Conventionally, a post-processing apparatus is known which, in accordance with instructions from the user, stacks sheets where an image is recorded, on a compile tray to align (match) the sheets, or binds the recording sheet bundle aligned in the compile tray with a stapler, and which discharges the bundle to a stacker tray.

### SUMMARY

According to an aspect of the invention, there is provided a post-processing apparatus including: a compile tray which includes an one-end aligning portion that aligns one end edge of a bundle of recording media, and on which image-recorded recording media are to be stacked; a post-processing member which performs a post processing on recording media stacked on the compile tray; a stacker tray to which a bundle of recording media that the post processing is performed is discharged and stacked; a sheet conveying path including: a discharging path through which the recording medium is discharged to the compile tray; a waiting path which is connected to the discharging path, and in which the recording medium to be discharged to the compile tray waits; and a discharging-path switching member which switches whether the recording medium is conveyed from the discharging path to the waiting path or not; a sheet conveying member which is placed in the discharging path, which discharges the recording medium to the compile tray, and which can discharge a recording medium waiting in the waiting path and a recording medium conveyed through the discharging path, to the compile tray while overlapping the recording media; a one-end alignment medium conveying member which is in contact with one face side of the bundle of recording media stacked on the compile tray, and which butts the conveyed recording media against the one-end aligning portion to align the conveyed recording medium; a discharging member which is in contact with another face side of the bundle of recording media stacked on the compile tray, and which discharges the bundle to the stacker tray; and a discharging-member controlling section which, when the post processing is performed on the bundle of recording media, drives the discharging member to discharge the bundle to the stacker tray, and which, when the recording media in an overlapped state are conveyed to the compile tray, drives the discharging member in reverse rotation to butt the recording medium on the other face side against the one-end aligning portion to align the recording medium.

### BRIEF DESCRIPTION OF THE DRAWINGS

Exemplary embodiment(s) of the present invention will be described in detail based on the following figures, wherein:

FIG. 1 is a diagram illustrating the whole of an image forming apparatus (tandem digital color copier) of Example 1 of the invention;

FIG. 2 is an enlarged view of main portions of the post-processing apparatus of Example 1 of the invention, and illustrating vertical movement of a discharging clamp roller;

FIG. 3 is an enlarged view of main portions of the post-processing apparatus of Example 1 of the invention, and illustrating vertical movement of a sub-paddle;

FIGS. 4A and 4B are enlarged views of main portions of a sheet waiting path in Example 1 of the invention, FIG. 4A is a diagram of the case where a first recording sheet is conveyed to a sheet waiting path, and FIG. 4B is a diagram of the case where the front ends of first and second recording sheets are aligned with each other;

FIG. 5 is an enlarged diagram of main portions of a rear end portion in a sheet discharging direction of an end-stitching device in Example 1;

FIG. 6 is a view as seen from the direction of the arrow VI in FIG. 5;

FIG. 7 is a section view taken along the line VII-VII in FIG. 6;

FIGS. 8A and 8B are views illustrating tampers of the end-stitching device in Example 1, FIG. 8A is a view illustrating a front tamper, and FIG. 8B is a view illustrating a rear tamper;

FIG. 9 is a section view taken along the line IX-IX in FIG. 8B;

FIGS. 10A, 10B and 10C are views illustrating a rear-end aligning member, FIG. 10A is a view illustrating a main paddle, FIG. 10B is a view illustrating a cone paddle, and FIG. 10C is a view illustrating a rotary brush;

FIG. 11 is a perspective view illustrating a portion of a discharging roller of a compile tray;

FIGS. 12A and 12B are views illustrating a clamp roller and a sub-paddle, FIG. 12A is a plan view, and FIG. 12B is a view as seen from the direction of the arrow XIIB in FIG. 12A;

FIG. 13 is a view illustrating a discharging device which discharges sheets stacked on the compile tray to a stacker tray TH1, and showing a state where sheets are stacked on the compile tray;

FIG. 14 is a view illustrating the discharging device which discharges sheets stacked on the compile tray to the stacker tray TH1, and showing a state where sheets stacked on the compile tray shown in FIGS. 12A and 12B are discharged to the stacker tray;

FIG. 15 is a view as seen from the direction of the arrow XV in FIG. 13, and illustrating members attached to a discharging roller shaft which is rotatably supported;

FIG. 16 is a view showing functions of controlling portions of the image forming apparatus of Example 1 in the form of a block diagram (functional block diagram);

FIG. 17 is a block diagram succeeding FIG. 16;

FIG. 18 is a flowchart of a sheet waiting process in a end-stitching discharging path of the post-processing apparatus of the invention;

FIG. 19 is a flowchart of an end-stitching device controlling process in an end-stitching device of the post-processing apparatus of the invention;

FIG. 20 is a flowchart of the rear-end aligning process in the end-stitching device of the post-processing apparatus of the invention;

FIG. 21 is a flowchart of the sheet discharging process in the end-stitching device of the post-processing apparatus of the invention, and illustrating a subroutine in ST113 of FIG. 19;

FIGS. 22A, 22B and 22C is a view illustrating the function of the post-processing apparatus of Example 1 having the above-described configuration, FIG. 22A is a view showing a state where the end-stitching process and the sheet discharging process are executed and no sheet is discharged on the compile tray (a state where the compile tray is empty), FIG. 22B is a view showing the initial state of the sheet introducing process in which the first and second recording sheets are introduced in an overlapping manner to the empty compile tray, and FIG. 22C is a view showing a state immediately before the end of the sheet introducing process;

FIG. 23A, 23B and 23C are views illustrating the function of the post-processing apparatus of Example 1 having the above-described configuration, FIG. 23A is a view showing a state immediately after the sheet introducing process is ended (a state immediately after the first and second recording sheets S1, S2 are discharged to the compile tray), FIG. 23B is a view showing the initial state of the rear-end aligning process, and FIG. 23C is a view showing a state immediately before the end of the rear-end aligning process;

FIGS. 24A, 24B and 24C is a view illustrating the rear-end aligning process in the case where a third recording sheet is discharged to the compile tray, FIG. 24A is a view showing a state where the third recording sheet is discharged to the compile tray, FIG. 24B is a view showing a state where a third sheet has been discharged to the compile tray, and FIG. 24C is a view showing a state where the third sheet is conveyed toward a sheet rear-end positioning member;

FIGS. 25A, 25B and 25C are views illustrating a state where a fourth sheet is discharged to the compile tray and the rear end of the sheet is conveyed to the sheet rear-end positioning member, and a fourth or subsequent sheet is discharged, FIG. 25A is a view showing a state where the fourth recording sheet is discharged to the compile tray, FIG. 25B is a view showing a state where an end-stitching process execution number of sheets have been discharged to the compile tray and discharged to the sheet rear-end positioning member, and FIG. 25C is a view showing a state where clamp rollers are contacted with the upper face of the end-stitching process execution number of sheets of FIG. 25B; and

FIGS. 26A, 26B and 26C are views illustrating the sheet discharging process in Example 1, and operations of the discharging rollers, shelves, set clamp paddles, and the like in the case where the end-stitching process execution number of recording sheets housed in the compile tray in a stacked state are discharged to a stacker tray, FIG. 26A is a view showing a state in the course where the end-stitching process execution number of recording sheets are discharged to the stacker tray by rotating the discharging rollers in the state of FIG. 25C, FIG. 26B is a view showing a state immediately before the discharging of the end-stitching process execution number of recording sheets to the stacker tray is ended, and FIG. 26C is a view showing a state where the discharging of the end-stitching process execution number of recording sheets to the stacker tray is ended.

### DESCRIPTION OF REFERENCE NUMERALS AND SIGNS

CA4b . . . discharging-path switch controlling section
CA5b . . . discharging-member controlling section
S, S1, S2 . . . recording medium
SH7b . . . discharging path
SH7c . . . waiting path
SH7 . . . sheet conveying path
TH1 . . . stacker tray
U4 . . . post-processing apparatus
12 . . . discharge path switching member
13 . . . sheet conveying member
14 . . . compile tray
21, 22 . . . tamper
21, 22, 70 . . . post-processing member
41a . . . one-end aligning portion
47 . . . one-end alignment medium conveying member
70 . . . stapler
82 . . . discharging member
91 . . . clamping member

### DETAILED DESCRIPTION

Next, exemplary embodiments (examples) of the invention will be described with reference to the accompany drawings. However, the invention is not restricted to the following examples.

In order to facilitate the understanding of the following description, the front and rear directions in the drawings are indicated as X-axis directions, the right and left directions are indicated as Y-axis directions, and the upper and lower directions are indicated as Z-axis directions. The directions or sides indicated by the arrows X, −X, Y, −Y, Z, and −Z are the front, rear, right, left, upper, and lower directions, or the front, rear, right, left, upper, and lower sides, respectively.

In the figures, the symbol in which “” is written in “◯” indicates the arrow which is directed from the rear of the sheet to the front, and that in which “×” is written in “◯” indicates the arrow which is directed from the front of the sheet to the rear.

### EXAMPLE 1

### EXAMPLE 1

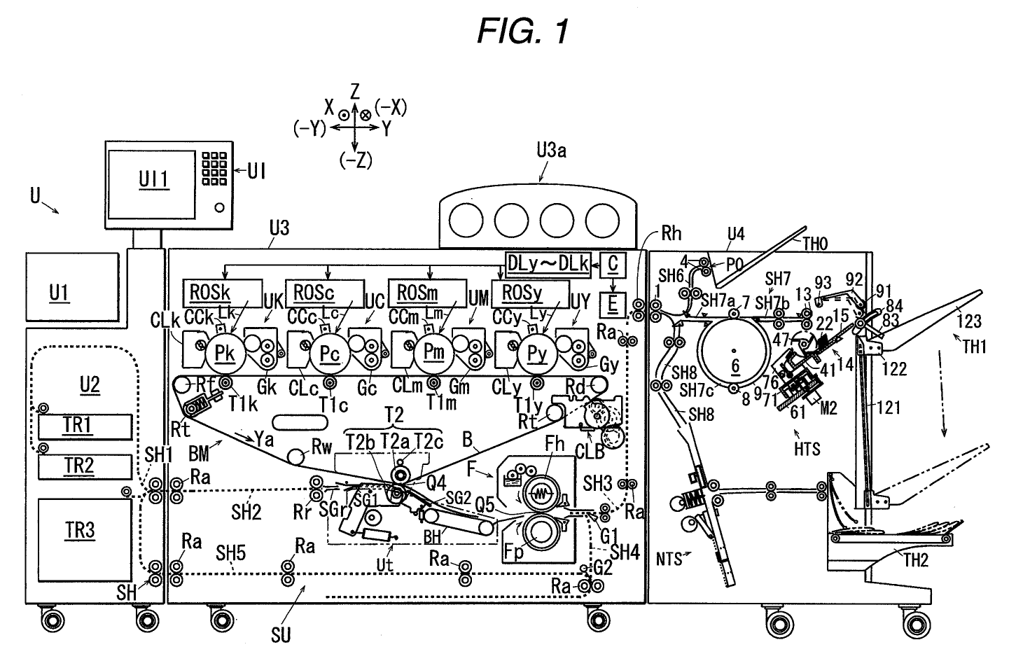

FIG. 1 is a diagram illustrating the whole of an image forming apparatus (tandem digital color copier) of Example 1 of the invention.

Referring to FIG. 1, the image forming apparatus U has a UI (user interface), an image inputting device U1, a sheet feeding device U2, an image forming apparatus body U3, and a post-processing apparatus U4.

### (Description of User Interface UI)

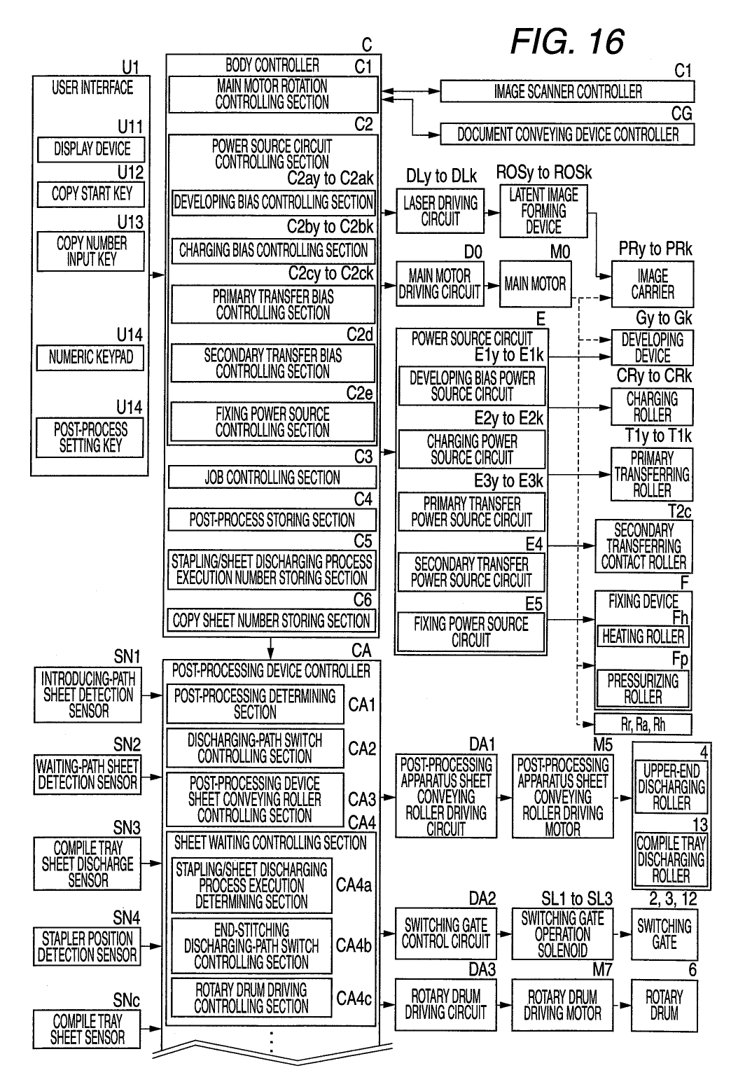

The UI has a display device U11, and input keys such as a copy start key U12 (see FIG. 16), a copy number input key U13 (see FIG. 16), a numeric keypad U14, and a post-processing setting key UI5.

### (Description of Image Inputting Device U1)

The image inputting device U1 is configured by an automatic document feeding device, an image scanner, etc.

Referring to FIG. 1, in the image inputting device U1, a reflected light from an illuminated document (not shown) is converted into image data of R (red), G (green), and B (blue) by an exposure optical system (not shown), a CCD (solid-state image pickup device), and an image processing circuit (not shown), and then input to the image forming apparatus body U3 at a predetermined timing.

### (Description of Sheet Feeding Device U2)

The sheet feeding device U2 has: plural sheet feeding trays TR1 to TR3; a sheet feeding path SH1 which takes out a recording sheet (recording medium) S that is used for image recording, and that is housed in the sheet feeding trays TR1 to TR3, and which conveys the sheet to the image forming apparatus body U3; etc.

### (Description of Image Forming Apparatus Body U3)

Referring to FIG. 1, the image forming apparatus body U3 has: an image recording portion (described later in detail) which records an image onto the recording sheet S conveyed from the sheet feeding device U2; a toner dispenser device U3a; a sheet conveying path SH2; a sheet discharging path SH3; a sheet inverting path SH4; a sheet circulating path SH5; etc.

The image forming apparatus body U3 further has: a controller C; laser driving circuits DLy to DLk which are controlled by the controller C; a power source circuit E; and the like. The laser driving circuits DLy to DLk which are controlled by the controller C supply laser driving signals respectively corresponding to image data of Y (yellow), M (magenta), C (cyan), and K (black) supplied from the image inputting device U1, at a predetermined timing to latent-image forming apparatuses ROSy, ROSm, ROSc, ROSk of toner image forming apparatuses UY, UM, UC, UK for respective colors. Each of the color toner image forming apparatuses UY, UM, UC, UK for respective colors is supported so as to be movable between a drawn-out position where the device is draw out to the front of the image forming apparatus body U3, and an attached position in the image forming apparatus body U3.

Referring to FIG. 1, a charging device CCk, a developing device Gk, a cleaner CLk, and the like are arranged around a photosensitive drum (toner-image carrier) Pk of the image carrier unit UK for K (black).

Similarly with the periphery of the photosensitive drum Pk, charging devices CCy, CCm, CCc, developing devices Gy, Gm, Gc, cleaners CLy, CLm, CLc, and the like are arranged also around photosensitive drums Py, Pm, Pc of the other toner image forming apparatuses UY, UM, UC.

Referring to FIG. 1, the photosensitive drums Py, Pm, Pc, Pk are uniformly charged by the charging devices CCy, CCm, CCc, CCk, and then electrostatic latent images are formed on the surfaces of the drums by laser beams Ly, Lm, Lc, Lk which are output from the latent-image forming apparatuses ROSy, ROSm, ROSc, ROSk, respectively. The electrostatic latent images on the surfaces of the photosensitive drums Py, Pm, Pc, Pk are developed to toner images of the colors or Y (yellow), M (magenta), C (cyan), and K (black) by the developing devices Gy, Gm, Gc, Gk, respectively.

The toner images on the surfaces of the photosensitive drums Py, Pm, Pc, Pk are sequentially transferred by primary transferring rollers T1y, T1m, T1c, T1k in an overlapping manner onto an intermediate transfer belt B, to form a color image on the intermediate transfer belt B. The color toner image formed on the intermediate transfer belt B is conveyed to a secondary transferring region Q4.

In the case where only black color image data exists, only the photosensitive drum Pk and the developing device Gk for K (black) are used, and only a black toner image is formed.

After the primary transfer, residual toners on the surfaces of the photosensitive drums Py, Pm, Pc, Pk are cleaned by the photosensitive drum cleaners CLy, CLm, CLc, CLk.

A belt module BM has: the intermediate transfer belt B; belt supporting rollers (Rd, Rt, Rw, Rf, T2a) including a belt driving roller Rd, a tension roller Rt, a walking roller Rw, plural idler rollers (free rollers) Rf, and a backup roller Ta; and the primary transferring rollers T1y, T1m, T1c, T1k. The intermediate transfer belt B is supported so as to be rotationally movable in the direction of the arrow Ya by the belt supporting rollers (Rd, Rt, Rw, Rf, T2a).

A secondary transferring unit Ut is placed below the backup roller T2a. A secondary transferring roller T2b of the secondary transferring unit Ut is placed so as to be separable from and pressingly contactable with (separable from and contactable with) the backup roller T2a across the intermediate transfer belt B. The secondary transferring region Q4 is formed by a region (nip) where the secondary transferring roller T2b is pressingly contacted with the intermediate transfer belt B. A contact roller T2c abuts against the backup roller T2a. A secondary transferring device T2 is configured by the rollers T2a to T2c.

A secondary transfer voltage having the same polarity as the charging polarity of the toner is applied to the contact roller T2c at a predetermined timing by the power source circuit which is controlled by the controller C.

The sheet conveying path SH2 in which sheet conveying rollers Ra, a registration roller Rr, and the like are arranged is placed below the belt module BM. The recording sheet S fed through the sheet feeding path SH1 of the sheet feeding device U2 is conveyed to the registration roller Rr of the sheet conveying path SH2, and then conveyed to the secondary transferring region Q4 through a registration-side sheet guide SGr and a pre-transfer sheet guide SG1 in timing with the conveyance of the color toner image to the secondary transferring region Q4.

The registration-side sheet guide SGr is supported together with the registration roller Rr by the image forming apparatus body U3.

When the color toner image on the intermediate transfer belt B is passed through the secondary transferring region Q4, the color toner image is transferred to the recording sheet S by the secondary transferring device T2. In the case of a full-color image, toner images which are overlappingly primary-transferred to the surface of the intermediate transfer belt B are collectively secondary-transferred to the recording sheet S.

After the secondary transfer, the intermediate transfer belt B is cleaned by a belt cleaner CLB. The secondary transferring roller T2b and the belt cleaner CLB are placed so as to be contactable with and separable from the intermediate transfer belt B, and, in the case of formation of a color image, separated from the intermediate transfer belt B until the unfixed toner image of the final color is primary-transferred to the intermediate transfer belt B.

The recording sheet S to which the toner image has been secondary-transferred is conveyed through a post-transfer sheet guide SG2 and a sheet conveying belt BH to a region (fixing region) Q5 where a pair of fixing rollers Fh of the fixing device F and a pressurizing roller Fp are pressingly contacted with each other. When the toner image on the recording sheet S is passed through the fixing region Q5, the toner image is heat-fixed by the fixing device F. A switching gate GT1 is placed on the downstream side of the fixing device F. The switching gate GT1 selectively switches a path for the recording sheet S which has been conveyed through the sheet conveying path SH2 and undergone the heat fixation in the fixing region Q5, to one of the sheet discharging path SH3 and the sheet inverting path SH4. The sheet S which is conveyed to the sheet discharging path SH3 is discharged to the post-processing apparatus U4 by the sheet conveying rollers Ra, a discharging roller Rh, etc.

A sheet circulating path SH5 is connected to the sheet inverting path SH4, and a mylar gate G2 is disposed in the connecting portion. The mylar gate G2 allows the recording sheet S conveyed to the sheet inverting path SH4 to pass therethrough as it is, and the recording sheet S which is switched back after passing, to be conveyed toward the sheet circulating path SH5. The recording sheet S which is conveyed to the sheet circulating path SH5 is passed through the sheet feeding path SH1 to be again sent to the transferring region Q4.

A sheet conveying path SH is configured by the components denoted by the reference numerals SH1 to SH5. A sheet conveying device SU is configured by the components denoted by the reference numerals SH, Ra, Rr, Rh, SG1, SG2, SGr, BH, G1, G2.

### (Description of Post-Processing Apparatus U4)

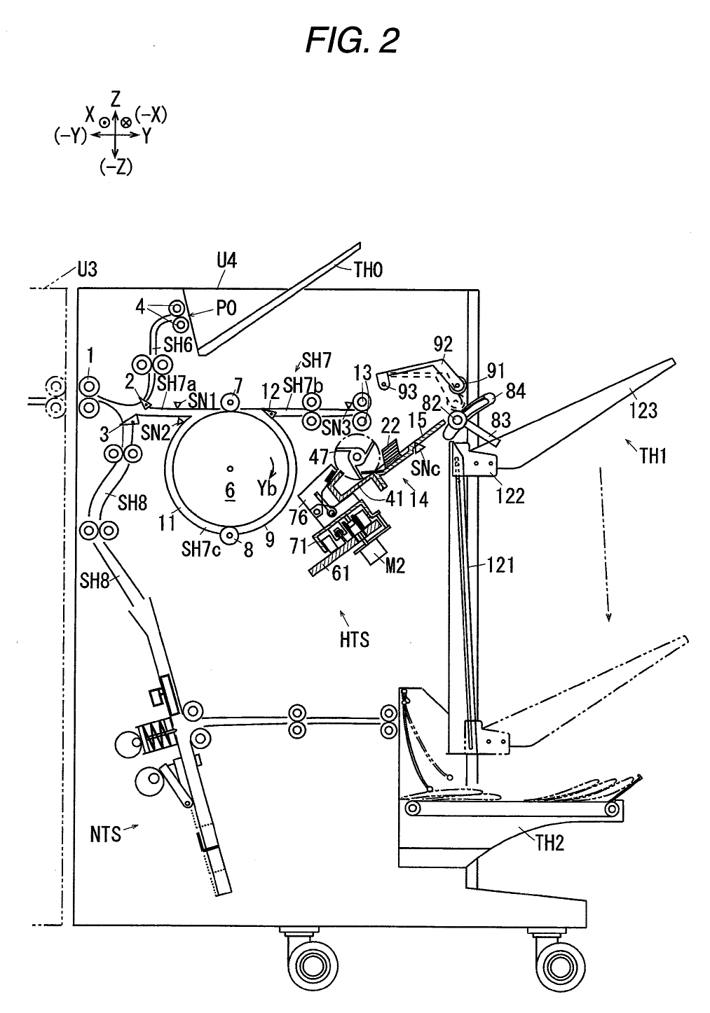

FIG. 2 is an enlarged view of main portions of the post-processing apparatus of Example 1 of the invention, and illustrating vertical movement of a discharging clamp roller.

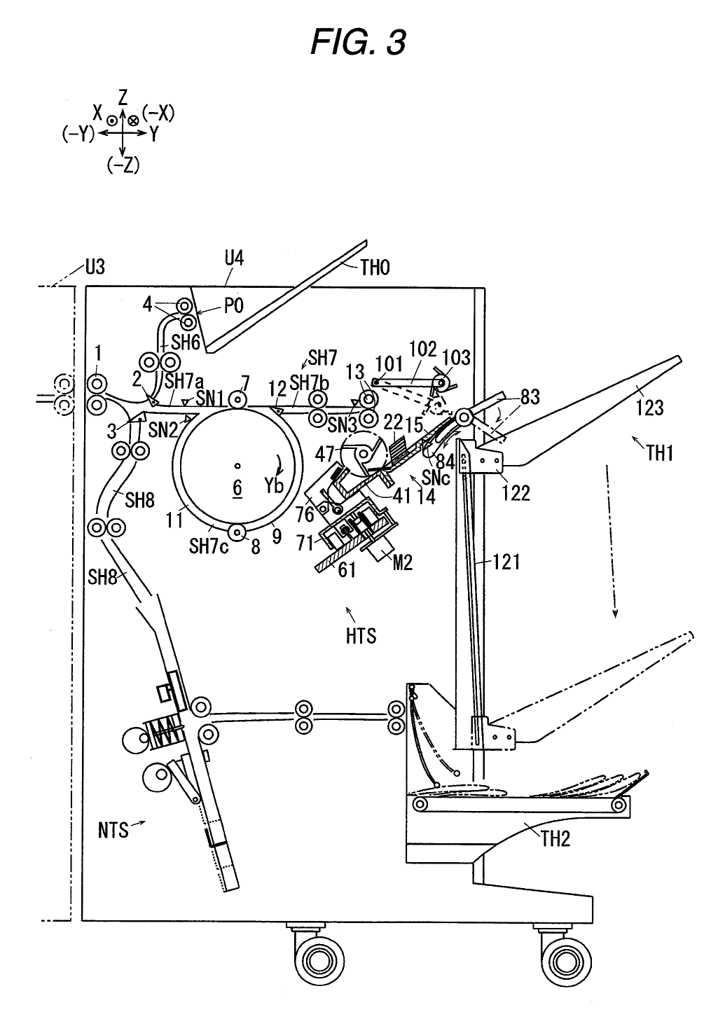

FIG. 3 is an enlarged view of main portions of the post-processing apparatus of Example 1 of the invention, and illustrating vertical movement of a sub-paddle.

Referring to FIGS. 2 and 3, in the post-processing apparatus U4, a sheet introducing port 1 which receives the recording sheet S that has undergone the copying process in the image forming apparatus body U3 is disposed in a face (one side face of the post-processing apparatus) which is connected with the image forming apparatus body U3. The recording sheet S introduced from the sheet introducing port 1 is conveyed to one of an upward-extending upper-end discharging path SH6, a rightward-extending end-stitching discharging path (sheet conveying path) SH7, and a downward-extending saddle stitching discharging path SH8 by switching the switching gates 2, 3. The recording sheet S conveyed to the upper-end discharging path SH6 is discharged as it is from an upper-end discharging port P0 to a top tray TH0 by an upper-end discharging roller 4. Namely, a top-tray discharging process of discharging the recording sheet S to the top tray TH0 is executed.

### (Description of Sheet Waiting Path SH7c)

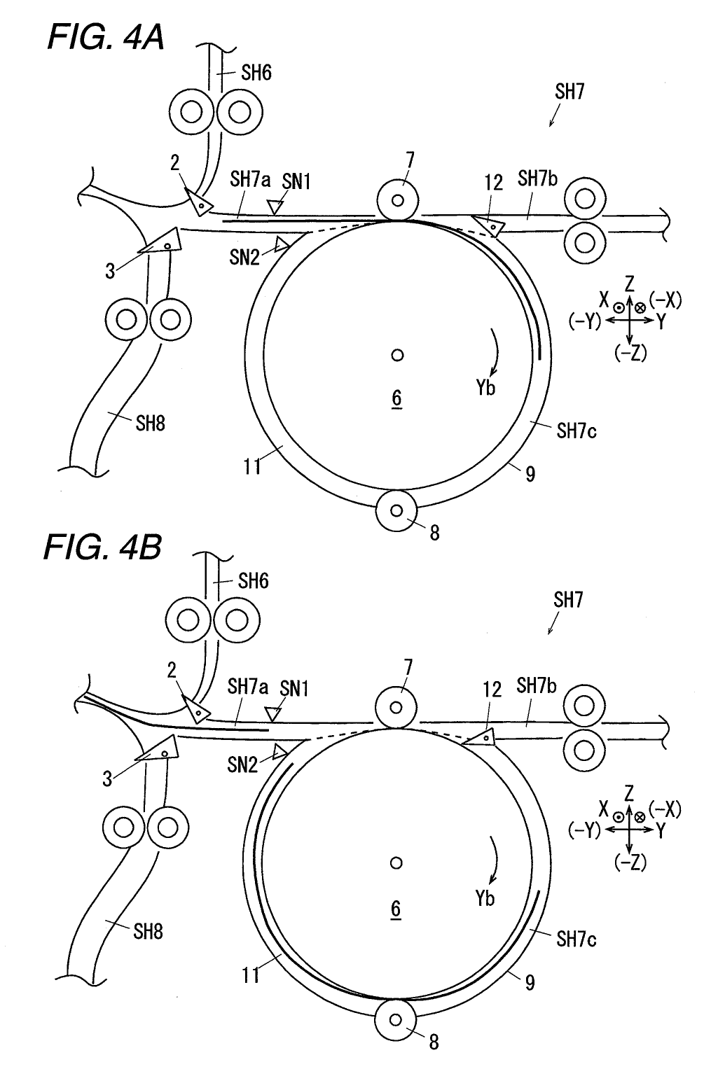

FIG. 4 is an enlarged view of main portions of a sheet waiting path in Example 1 of the invention, FIG. 4A is a diagram of the case where a first recording sheet is conveyed to the sheet waiting path, and FIG. 4B is a diagram of the case where the front ends of first and second recording sheets are aligned with each other.

Referring to FIGS. 4A and 4B, the end-stitching discharging path SH7 has: a sheet introducing path SH7a which receives the recording sheet S; and a sheet discharging path SH7b which is connected to the right side of the sheet introducing path SH7a, and which is used for discharging the recording sheet S. A cylindrical rotary drum 6 which is rotated in the direction of the arrow Yb, and an upper driven roller 7 which abuts against the upper side of the rotary drum 6 are placed between the sheet introducing path SH7a and the sheet discharging path (discharging path) SH7b. A lower driven roller 8 which abuts against the lower side of the rotary drum 6, and arcuate guide members 9, 11 which cover the outer circumference of the rotary drum 6 are placed on the rotary drum 6.

An annular sheet waiting path (waiting path) SH7c is configured by a space among the rotary drum 6, the lower driven roller 8, and the guide members 9, 11.

The sheet waiting path SH7c joins the sheet introducing path SH7a at a joining position upstream from an abutting position where the rotary drum 6 and the upper driven roller 7 abut against each other. An introducing-path sheet detection sensor SN1 for detecting the recording sheet S conveyed through the sheet introducing path SH7a is placed in the sheet introducing path SH7a. A waiting-path sheet detection sensor SN2 for detecting the recording sheet S which is discharged from the sheet waiting path SH7c to the sheet introducing path SH7a is placed in the sheet waiting path SH7c.

The sheet waiting path SH7c branches from the sheet discharging path SH7b at a branching position downstream from the abutting position. A switching gate (discharge path switching member) 12 is placed in the branching position. The switching gate 12 is configured so as to be movable between a waiting-path conveying position (see FIG. 4A) where the recording sheet S is conveyed toward the sheet waiting path SH7c, and a discharging-path conveying position (see FIG. 4B) where the recording sheet S is conveyed toward the sheet discharging path SH7b.

### (Description of End-Stitching Device HTS)

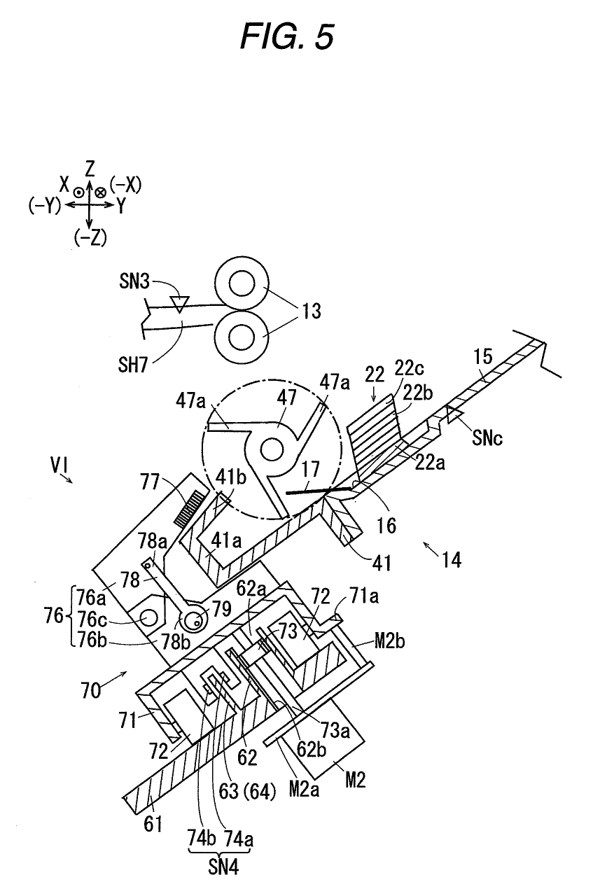

FIG. 5 is an enlarged diagram of main portions of a rear end portion in a sheet discharging direction of an end-stitching device in Example 1.

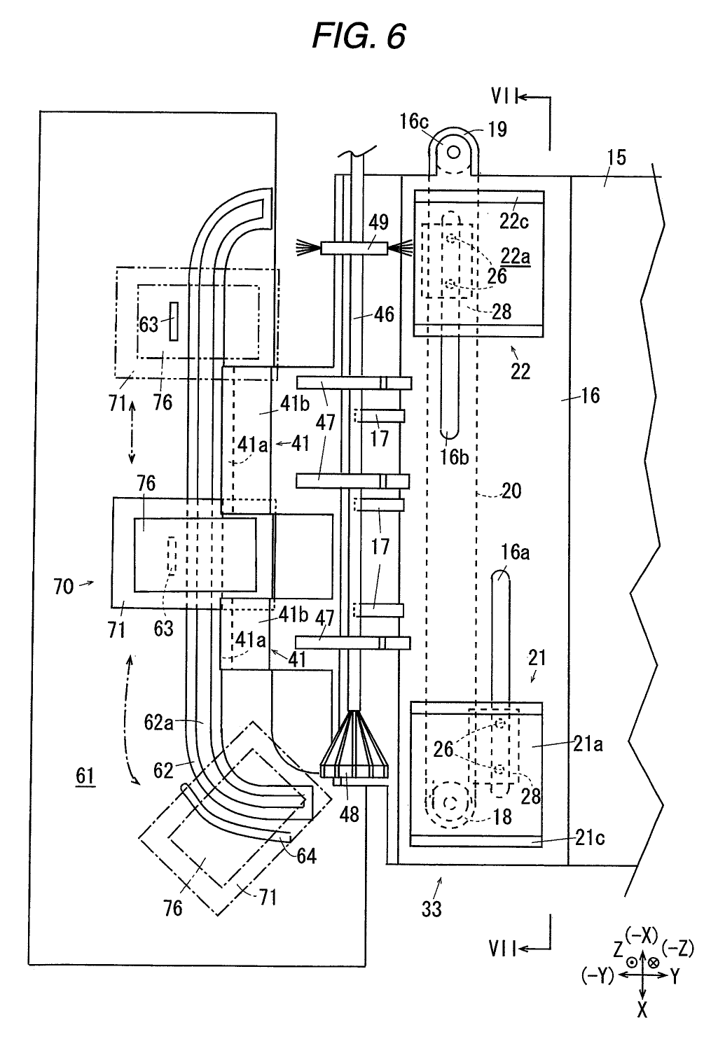

FIG. 6 is a view as seen from the direction of the arrow VI in FIG. 5.

Referring to FIGS. 2 and 3, the recording sheet S conveyed through the end-stitching discharging path SH7 is discharged to a compile tray (end-stitching compile tray) 14 by a compile tray discharging roller (sheet conveying member) 13. A compile tray sheet discharge sensor SN3 for detecting the recording sheet S conveyed through the end-stitching discharging path SH7 is placed in the vicinity of the compile tray discharging roller 13. The compile tray 14 is placed so as to be slightly inclined with respect to the horizontal, and configured so that it can house plural sheets while aligning them with each other.

Referring to FIGS. 2, 3, and 5, the compile tray 14 has a compile tray body 15 on which recording sheets are to be stacked. A tamper movement recess 16 is formed in a left end portion of the upper face of the compile tray body 15, and a pair of front and rear tamper guide grooves 16a, 16b (see FIG. 6) are formed in the tamper movement recess 16.

A compile tray sheet sensor SNc for detecting whether the sheet S exists or not is disposed in the compile tray 14.

Referring to FIGS. 5 and 6, a right end portion (basal end portion) of a film-like (thin film-like) mylar (sheet lifting member) 17 is fixedly supported by a left end portion of the tamper movement recess 16, and a left end portion (tip end portion) of the mylar 17 is upward projected from the upper face of the compile tray body 15. The rigidity (strength) of the mylar 17 in Example 1 is set to a degree that, in a state where a few (about 5 in case of plain paper) recording sheets are stacked on the compile tray body 15, the mylar lifts the recording sheets (or a bundle of the recording sheets), and, in a state where many recording sheets are stacked, the mylar is elastically deformed by the weight of a bundle of the recording sheets, and the tip end portion of the mylar 17 is closely contacted with the upper face of the compile tray 14. Even when the number of housed sheets is small, therefore, the distance between the uppermost face of a housed recording sheet bundle and a main paddle (one-end alignment medium conveying member) 47 which will be described later can be held to a predetermined distance by the mylar 17.

### (Description of Sheet Side-Edge Aligning Member 33)

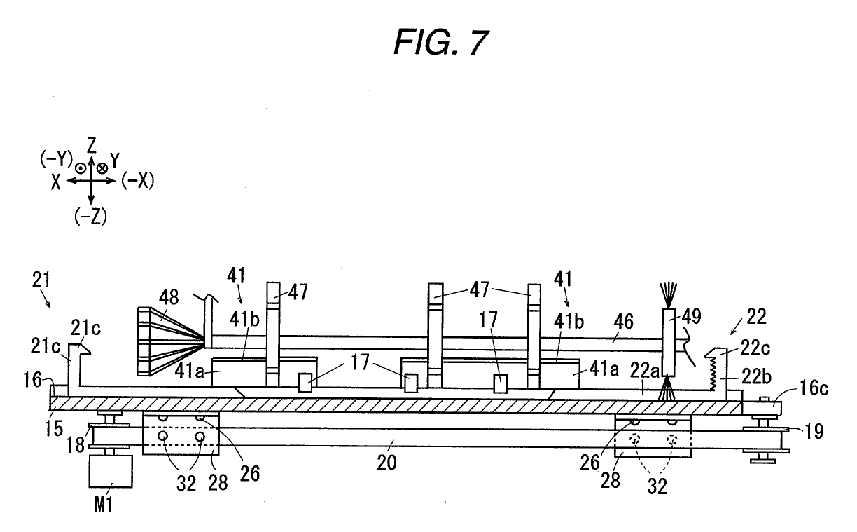

FIG. 7 is a section view taken along the line VII-VII in FIG. 6.

Referring to FIG. 7, a tamper driving pulley 18 which can be rotated forwardly and reversely by a tamper driving motor M1 is supported on a front portion of the lower face of the tamper movement recess 16. A driven pulley 19 is rotatably supported by a pulley supporting portion in a rear portion of the tamper movement recess 16. A tamper driving timing belt 20 is stretched (attached) between the tamper driving pulley 18 and the driven pulley 19.

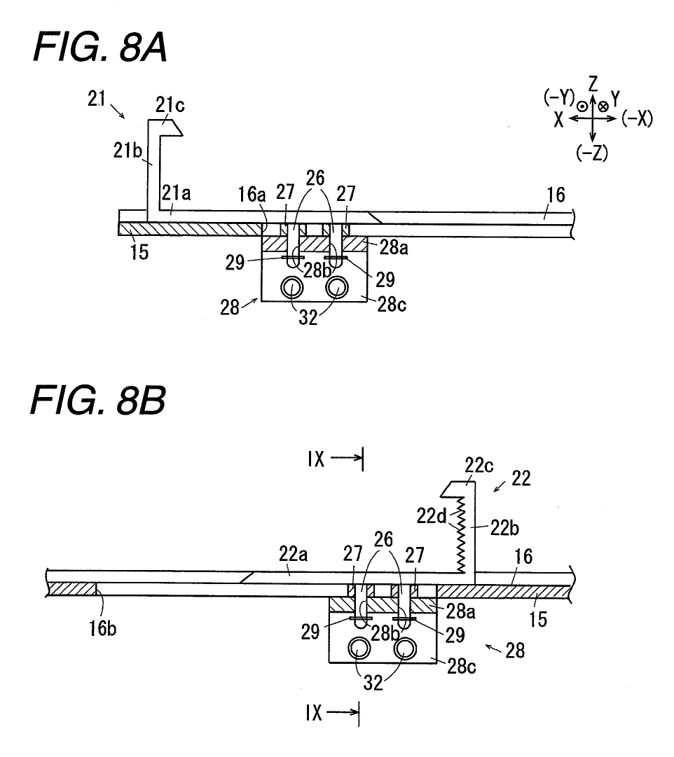

FIGS. 8A and 8B are views illustrating the tampers of the end-stitching device in Example 1, FIG. 8A is a view illustrating a front tamper, and FIG. 8B is a view illustrating a rear tamper.

Referring to FIGS. 5 to 8, the pair of the front and rear tampers (post-processing member) 21, 22 for aligning font and rear side edges of a sheet conveyed to the compile tray 14 are placed in the tamper movement recess 16. Referring to FIG. 8A, the front tamper 21 has: a sheet placement portion (tamper base) 21a in which the upper face is substantially flush with the upper face of the compile tray body 15, and a rear end portion (−X end portion) is downward inclined; and a sheet side end alignment wall 21b which is upward raised from the front end of the sheet placement portion 21a. A sheet side edge engaging portion 21c which is inward projected is formed on the upper end of the sheet end alignment wall 21b. The sheet side edge engaging portion 21c prevents the front edge of a recording sheet on the compile tray 14 from riding over the front tamper 21, and a curled side edge of a sheet from upward sliding.

Referring to FIGS. 8A and 8B, similarly with the front tamper 21, the rear tamper 22 has a sheet placement portion (tamper base) 22a, a sheet side end alignment wall 22b, and a sheet side edge engaging portion 22c. Many ridges 22d which are parallel to the upper face of the compile tray body 15 are formed on the inner face (a pressing face which presses sheet side edges) of the sheet side end alignment wall 22b of the rear tamper 22. Therefore, the sheet side edge engaging portion 22c and the ridges 22d prevent the rear edge of a recording sheet from riding over the rear tamper 22.

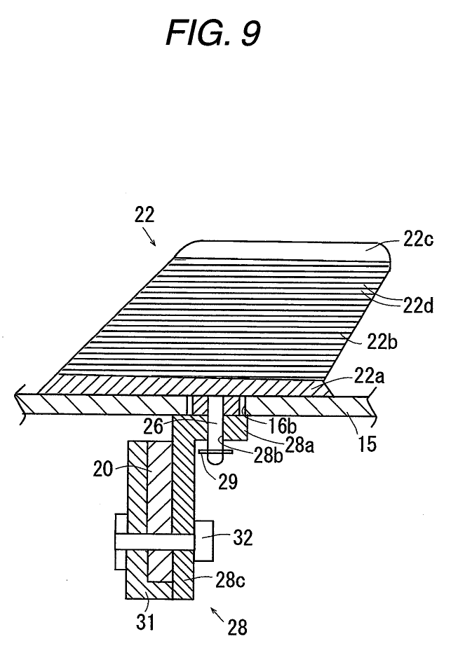

FIG. 9 is a section view taken along the line IX-IX in FIG. 8B.

Next, couplings between the front and rear tampers 21, 22 and the tamper driving timing belt 20 will be described. The coupling structure between the front tamper 21 and the tamper driving timing belt 20 is similar to that between the rear tamper 22 and the tamper driving timing belt 20. Therefore, the rear tamper 22 will be described in detail, and the description of the front tamper 21 is omitted.

Referring to FIGS. 8 and 9, two guided pins 26 are downward projected from the lower face of the sheet placement portion 22a of the rear tamper 22. The guided pins 26 downward extend with passing through the rear tamper guide groove 16b. Tubular collars 27 are fitted onto the guided pins 26, respectively. Tip end portions of the guided pins 26 are passed through pin through holes 28b formed in an upper end wall 28b of an inverted L-like tamper bracket 28. Locking clips 29 are attached to the tip ends of the guided pins 26. Referring to FIG. 9, a coupling plate 31 is placed opposedly to a vertical wall 28c of the tamper bracket 28. The tamper bracket 28 and the coupling plate 31 are coupled to each other by two coupling members 32 in a state where the tamper driving timing belt 20 is interposed therebetween.

In FIG. 6, the front tamper 21 is coupled to the right side of the tamper driving timing belt 20, and the rear tamper 22 is coupled to the left side of the tamper driving timing belt 20. When the tamper driving motor M1 (see FIG. 7) is rotated forwardly or reversely, therefore, the front and rear tampers 21, 22 can be moved in a mutually approaching or separating direction.

A sheet side-edge aligning member 33 is configured by the tamper driving motor M1, the tamper driving pulley 18, the driven pulley 19, the tamper driving timing belt 20, the tampers 21, 22, the guided pins 26, the tamper bracket 28, the coupling plate 31, the coupling members 32, etc. The sheet side-edge aligning member is not restricted to have the above-described configuration, and can employ any of various conventionally known configurations (for example, see JP-A-08-081111, JP-A-08-108965, etc.).

### (Description of Sheet Rear-End Positioning Member 41)

Referring to FIGS. 5 and 6, a sheet rear-end positioning member 41 is fixedly supported by a rear end side in the sheet discharging direction of the compile tray body 15. The sheet rear-end positioning member 41 has: a rear-end positioning wall (end wall, sheet end positioning portion, one-end aligning portion) 41a which is upward raised in order to position the discharging-direction rear end of a recording sheet conveyed to the compile tray 14; and a sheet guide wall 41b which extends from the upper end of the rear-end positioning wall 41a toward the compile tray body 15. As shown in FIG. 6, the rear-end positioning wall 41a is disposed in a portion other than a staple position where a staple work of stitching a recording sheet bundle by a stapler which will be described later is performed. The sheet guide wall 41b has a function of, when the rear end of a sheet which is moved toward the rear-end positioning wall 41a in order to perform sheet alignment is upward curled, downward guiding the sheet rear end to reduce the curl amount.

The compile tray 14 is configured by the compile tray body 15, the sheet rear-end positioning member 41, and the like.

The sheet rear-end positioning member 41 in Example 1 is fixedly supported by the compile tray body 15. The invention is not restricted to this. For example, a conventionally known sheet rear-end positioning member (for example, see JP-A-08-192951) which is swingable may be employed.

### (Description of Main Paddle 47)

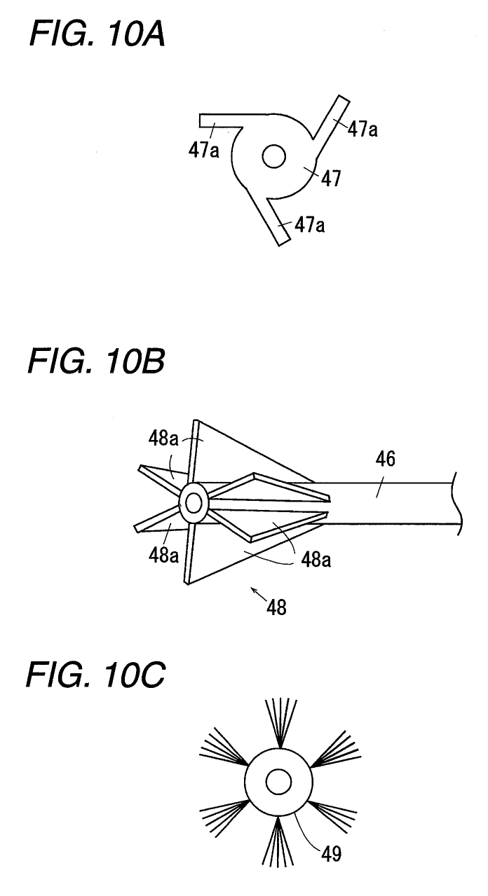

FIGS. 10A, 10B and 10C are views illustrating the sheet rear-end aligning member, FIG. 10A is a view illustrating the main paddle, FIG. 10B is a view illustrating a cone paddle, and FIG. 10C is a view illustrating a rotary brush.

Referring to FIGS. 6 and 7, above the sheet rear-end positioning member 41, a rear-end aligning member support shaft 46 is rotatably supported by a frame (not shown) of the post-processing apparatus U4. The rear-end aligning member support shaft 46 is rotated by a motor which is placed in a rear side, and which is not shown. Referring to FIGS. 6 and 7, three main paddles (sheet rear-end aligning member, sheet end aligning member, one-end alignment medium conveying member) 47 which are placed at positions corresponding to the sheet rear-end positioning member 41 with placing intervals in the front and rear direction (X-axis direction) are fixedly supported by the rear-end aligning member support shaft 46. As shown in FIG. 10A, each of the main paddles 47 has three flexible sheet contacting portions 47a, and conveys a recording sheet toward the rear-end positioning wall 41a while abutting against the upper face of the recording sheet (or the uppermost face of a recording sheet bundle) on the compile tray 14.

The sheet contacting portions 47a extend in a tangential direction from positions of a cylindrical face which are shifted from each other by 120°. The number and placement positions of the sheet contacting portions 47a are not restricted to the above-described configuration of three portions and 120°, and may have any one of configurations such as only a single portion, two portions and 180°, four portions and 90°, five portions and 72°, and six portions and 60°. The direction along which each sheet contacting portion 47a extends is not restricted to a tangential direction, and may be a radial direction.

In the main paddles 47 in Example 1, the distance between the main paddles 47 and the compile tray 14 is set so that, when many recording sheet bundles are housed in the compile tray 14, the contact pressure between each sheet contacting portion 47a and a recording sheet has an adequate value.

Referring to FIGS. 6, 7, and 10B, a cone paddle 48 is fixed to a front end portion of the rear-end aligning member support shaft 46. The cone paddle 48 is a sheet side-edge guiding rotary member which downward guides one side edge of a recording sheet that is forward moved, and has a conical rotation plane in which the outer diameter is larger as further forward advancing.

As shown in FIG. 10B, namely, the cone paddle 48 has six triangular fin members 48a which radially extend from positions of a cylindrical face that are shifted from each other by 60° in the circumferential direction. When the paddle is rotated, the outer side edges of the fin members 48a form a conical face. The cone paddle 48 has a function of, when an upward curled sheet is moved while approaching in the X direction, downward directing the upward curled portion of the sheet.

The rotary brush 49 (see FIGS. 6 and 7) is fixed to a rear end portion (−X end portion) of the rear-end aligning member support shaft 46. Referring to FIG. 10C, the rotary brush 49 has plural brush bristles (linear members) which radially extend from positions of a cylindrical face that are shifted from each other by 60° in the circumferential direction. The rotary brush 49 has a function of downward pressing a curl which is formed in a rear end portion of a sheet.

In the invention, the cone paddle 48 and the rotary brush 49 may be omitted.

### (Description of Stapler Guide Member 61)

In FIGS. 5 and 6, in a space left below the sheet rear-end positioning member 41, a stapler guide member 61 is fixedly supported by the frame (not shown) of the post-processing apparatus U4. In the stapler guide member 61, a stapler guide portion 62 which linearly extends in the front and rear direction, and in which front and rear end portions are inward arcuately bent are formed so as to be upward projected. In the stapler guide portion 62, a stapler guide groove 62a is formed along the stapler guide portion 62. Gear teeth 62b (see FIG. 5) are formed on one inner face of the stapler guide groove 62a.

A snap fit engaging portion (not shown) which prevents a movable staple member that will be described later from being further moved toward a front or rear side is disposed in the front and rear ends of the stapler guide portion 62.

In FIG. 6, on the left side of the stapler guide groove 62a, two staple position light-blocking portions (staple position detecting portions) 63 are disposed correspondingly with staple positions where the staple work of stitching side ends of recording sheets is performed. The staple position light-blocking portions 63 are formed so as to elongate in the front and rear direction along the linear guide groove 62a. In a front end portion of the stapler guide member 61, a home position light-blocking portion (home position detecting portion) 64 is formed along the arcuate bent portion of the guide groove 62a.

In Example 1, the staple position light-blocking portions 63 are set to have a front and rear direction length of 12.6 mm. The home position light-blocking portion 64 in Example 1 is formed so as to be sufficiently longer (for example, about 50 mm) than the staple position light-blocking portions 63, and used for detecting the home position, and also for detecting a corner stitching staple position where corner stitching for stitching an edge (corner) of a sheet bundle is performed.

### (Description of Movable Staple Member 70)

Referring to FIGS. 5 and 6, the movable staple member (post-processing member, stapler) 70 is placed above the stapler guide member 61. The movable staple member 70 has a carriage 71, and a shaft support portion 71a is formed in a right end portion (+Y end portion) of the carriage 71. Rollers 72 are rotatably supported by the carriage 71, and the carriage 71 is configured so as to be movable on the stapler guide member 61. A guide gear 73 is rotatably supported by the lower face of the carriage 71. The guide gear 73 is fitted into the stapler guide groove 62a, and meshes with the gear teeth 62b. A rotation shaft 73a of the guide gear 73 is passed through the stapler guide groove 62a, and a stapler driving motor M2 is coupled to a lower end portion of the shaft. The stapler driving motor M2 is supported by a motor support plate M2a. A motor support shaft M2b is coupled between a right end portion of the motor support plate M2a and the shaft support portion 71a. Therefore, the stapler driving motor M2 is configured so as to be movable integrally with the carriage 71.

When the stapler driving motor M2 is rotated forwardly or reversely, therefore, the guide gear 73 is rotated, and the carriage 71 is moved by the gear teeth 62b of the stapler guide groove 62a meshing with the guide gear 73, while being guided in the front and rear direction along the stapler guide portion 62. The stapler driving motor M2 in Example 1 is configured by a stepping motor which is rotated by a predetermined angle each time when a pulse is input. In Example 1, the stapler driving motor M2 is set so that the carriage 71 is moved in the front and rear direction at a speed of 31.5 cm/s. Therefore, the carriage 71 in Example 1 is set so that it is passed in 40 ms from the front end of the staple position light-blocking portions 63 to the rear end, and the passing through the home position light-blocking portion 64 requires 50 ms or longer. During execution of a stapling process, the carriage 71 is moved to the staple positions with reference to the home position which is a reference position for the start of the movement.

Referring to FIG. 5, a stapler position detection sensor SN4 is fixedly supported by the lower face of the carriage 71. The stapler position detection sensor SN4 is configured by an optical sensor having: a light emitting portion 74a which emits light; and a light receiving portion 74b which can receive the light emitted from the light emitting portion. The stapler position detection sensor SN4 is placed at position where, when the carriage 71 is moved to the staple positions or the home position, the staple position light-blocking portions 63 or the home position light-blocking portion 64 enter between the light emitting portion 74a and the light receiving portion 74b, thereby blocking the light. Therefore, the stapler position detection sensor SN4, and the staple position light-blocking portions 63 and the home position light-blocking portion 64 enable the carriage 71 to be moved between the staple positions (side end-stitching positions, the positions indicated by the solid line or the dash-dot-dot line in FIG. 6) and the home position (the reference position, the position indicated by the dash-dot line in FIG. 6).

A stapler body 76 is supported by the upper face of the carriage 71. The stapler body 76 has: a needle punching portion 76a which punches out a staple needle 77 for stitching a recording sheet bundle stacked on the compile tray 14; and a needle bending portion 76b which bends tip ends of the staple needle punched out from the needle punching portion 76a. The needle punching portion 76a is swingably supported on the needle bending portion 76b by a rotation shaft 76c. A tip end portion 78a of a stapler operating member 78 is pin-connected to the needle punching portion 76a. An eccentric cam 79 which is rotatably supported by the needle bending portion 76b is loosely fitted into an annular rear end portion 78b of the stapler operating member 78. When the eccentric cam 79 is rotated by a driving device which is not shown, therefore, the stapler operating member 78 is vertically moved, and the needle punching portion 76a is vertically moved, thereby performing the stapling process.

The movable staple member 70 is configured by the components denoted by the reference numerals 71 to 79.

### (Description of Discharging Roller 82, Shelf 84, and Set Clamp Paddle 83)

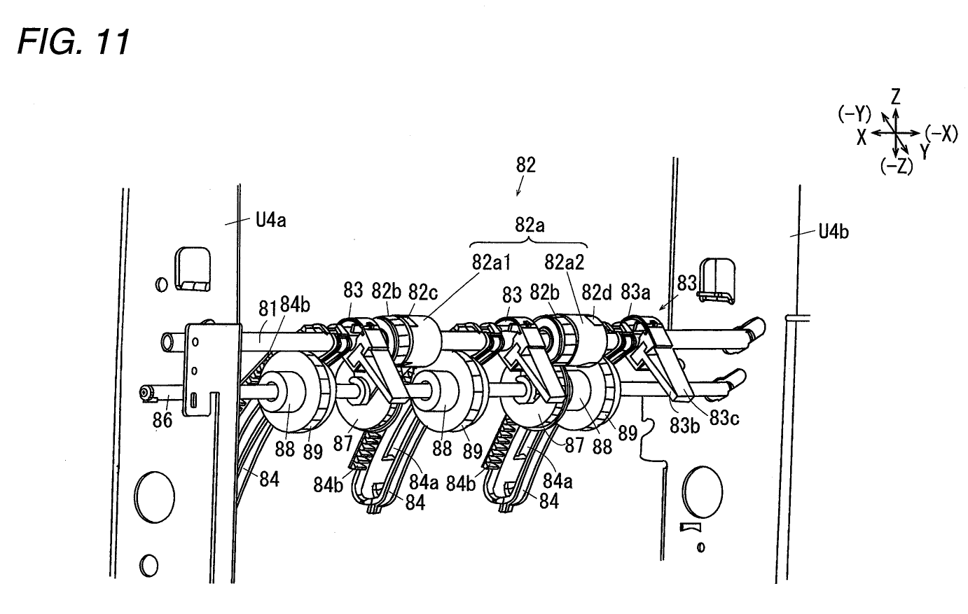

FIG. 11 is a perspective view illustrating a portion of a discharging roller of the compile tray.

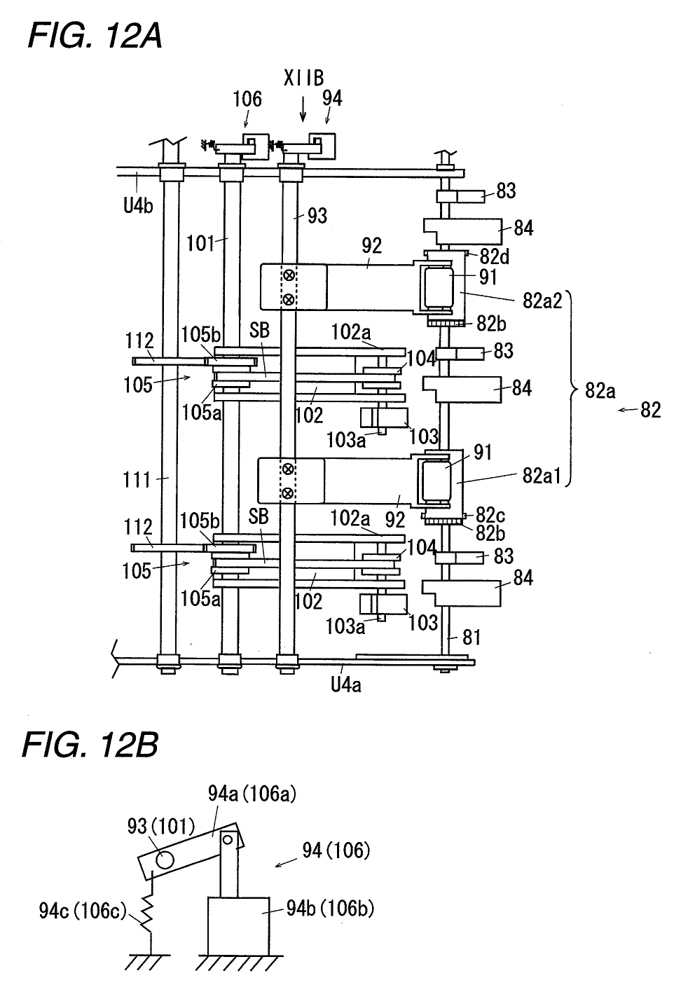

FIGS. 12A and 12B are views illustrating a clamp roller and a sub-paddle, FIG. 12A is a plan view, and FIG. 12B is a view as seen from the direction of the arrow XIIB in FIG. 12A.

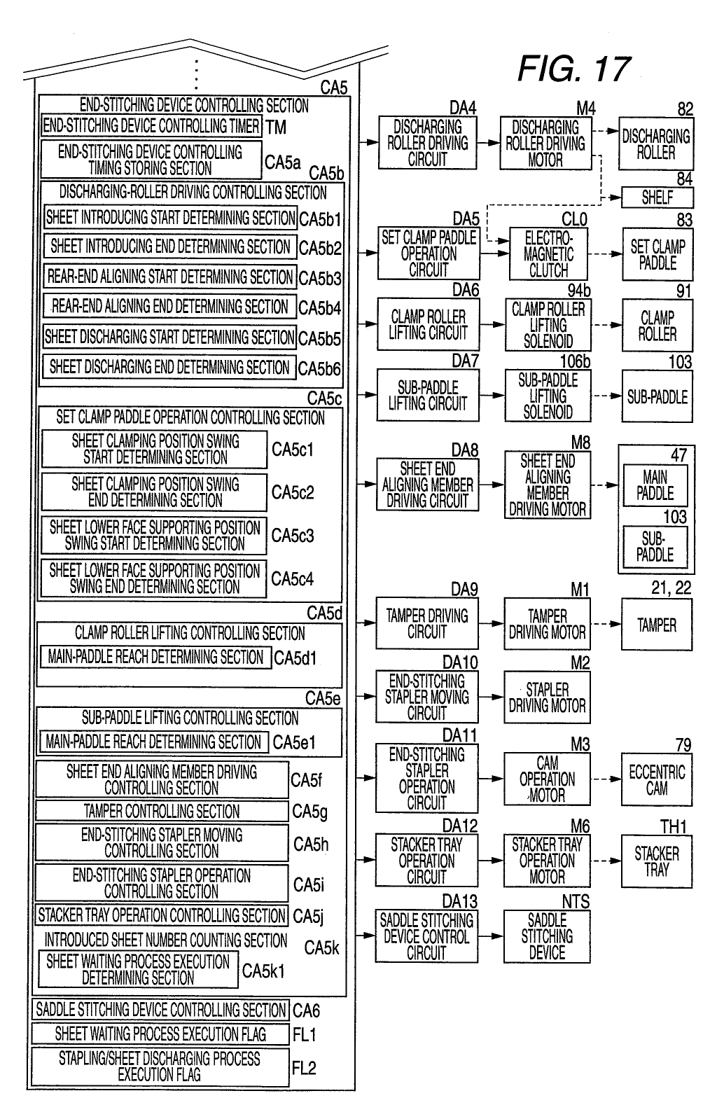

Referring to FIGS. 2, 3, 11, and 12, a discharging roller shaft (stacker tray discharging roller shaft) 81 which is rotatably supported between front and rear frames U4a, U4b of the post-processing apparatus U4 is disposed in front of the compile tray 14 in the sheet discharging direction. A driving force is transmitted from a stacker tray discharging roller driving motor M4 (see FIG. 17) which can rotate forwardly and reversely, to the discharging roller shaft 81 via an electromagnetic clutch which is not shown.

Referring to FIGS. 11 and 12, two discharging rollers (stacker tray discharging rollers, discharging members) 82 are rotatably supported on the discharging roller shaft 81 with forming a gap in the front and rear direction. Each of the discharging rollers 82 has a discharging roller body 82a, and a roller gear (discharging roller gear) 82b which is fixedly supported on the front end face of the discharging roller body 82a.

In the discharging roller body 82a, three lower sheet conveying vanes 82c, 82d are fixedly supported at regular intervals (intervals of 120°) along the circumferential direction in each of a front end portion of a front discharging roller body 82a1 which is placed in the front side (+X side), and a rear end portion of a rear discharging roller body 82a2 which is placed in the rear side (−X side). As shown in FIGS. 12A and 12B, the lower sheet conveying vanes 82c, 82d extend in a tangential direction of the outer circumferential face of the discharging roller body 82a. The lower sheet conveying vanes 82c, 82d are flexible, and can be produced by a resin such as PET (polyehylene-terephtalate). When the lower face of the recording sheet S (in the case where the recording sheet S is a bundle, the lowermost face of the bundle) on the compile tray 14 abuts against the lower sheet conveying vanes 82c, 82d, therefore, the lower sheet conveying vanes 82c, 82d are pressed in the downward direction (−Z direction) by the weight of the recording sheet S to be in a flexed state. As a result, the lower sheet conveying vanes 82c, 82d are pressed against the lower face of the recording sheet S at a predetermined force by the elastic resilient forces of the flexed lower sheet conveying vanes 82c, 82d, so that, when the discharging rollers 82 are rotated, a conveying force can be surely applied.

The lower sheet conveying vanes 82c, 82d are placed with avoiding a range where the recording sheet S (recording sheet bundle) is clamped by the discharging roller bodies 82a and clamp rollers (clamping members) 91 (see FIGS. 12A and 12B) which will be described later, i.e., the middle portions of the discharging roller bodies 82a, 82b.

Three set clamp paddles 83 which are arranged with forming intervals are fixedly supported on the discharging roller shaft 81. Each of the set clamp paddles 83 has: a cylindrical core portion 83a; a sheet pressing portion 83b which is fixedly supported by the core portion 83a, and which is elastically deformable; and a low-friction film (low-friction member) 83c which is fixedly supported by the core portion 83a, and which reduces the friction resistance with respect to a recording sheet.

A stacker tray discharging rotary member (81 to 83) is configured by the components denoted by the reference numerals 81 to 83.

Three shelves (sheet lower face supporting members) 84 which are arranged with forming intervals are disposed on the discharging roller shaft 81. In each of the shelves 84, a guided long hole 84a which extends along the sheet discharging direction, and through which the discharging roller shaft 81 is passed is formed. In the shelf 84, an arcuate rack gear 84b (see FIG. 11) which extends along the sheet discharging direction is formed.

Referring to FIG. 11, a driving shaft (discharging roller rotating driving shaft) 86 to which the driving force is transmitted from the stacker tray discharging roller driving motor M4 (see FIG. 17) is placed below the discharging roller shaft 81. Discharging roller driving gears 87 which mesh with the roller gears 82b of the discharging rollers 82 (see FIGS. 12A and 12B) are fixedly supported on the driving shaft 86. Shelf operating gears (shelf moving gears) 89 which have a torque limiter 88, and which mesh with the rack gears 84b of the shelves 84 are fixedly supported on the driving shaft 86. In accordance with the forward or reverse rotation of the stacker tray discharging roller driving motor M4, therefore, the discharging rollers 82 are rotated forwardly or reversely, and the shelves 84 are guided by the discharging roller shaft 81 so that the shelves are moved between a sheet lower face supporting position shown in FIG. 2 and a housed position shown in FIG. 3. In a state where the shelves 84 are moved to the sheet lower face supporting position or to the housed position, when rotation for moving the shelves 84 forward or rearward is further transmitted from the driving shaft 86, the torque limiters 88 cause the driving shaft 86 to be idly rotated with respect to the shelf operating gears 89.

In accordance with the rotation of the discharging roller shaft 81 due to an on/off operation of an electromagnetic clutch CL0 (see FIG. 17), the set clamp paddles 83 are swung between a sheet clamping position (see FIG. 2) where the paddles abut against the upper face of a sheet bundle on a stacker tray (TH1) which will be described later, and the sheet lower face supporting position (see FIG. 3) where, in a state where the shelves 84 are held to the housed position, the paddles support the lower face of a recording sheet discharged onto the compile tray 14.

### (Description of Clamp Roller 91)

Referring to FIGS. 2 and 12, the clamp rollers 91 are placed above the discharging rollers 82. Each of the clamp rollers 91 is rotatably supported on a plate spring-like clamp roller supporting member 92. A left end portion of the clamp roller supporting member 92 is fixedly supported by a clamp roller lifting shaft 93 which is rotatably supported on the frames U4a, U4b. A clamp roller lifting member 94 is disposed on the rear end of the clamp roller lifting shaft 93. The clamp roller lifting member 94 has: a lifting bar 94a which is coupled to the rear end of the clamp roller lifting shaft 93; a clamp roller lifting solenoid 94b which is coupled to a right end portion of the lifting bar 94a; and a tension spring 94c which is coupled to a left end portion of the lifting bar 94a.

In a state where the clamp roller lifting solenoid 94b is in the off state, therefore, the clamp rollers 91 are held to a waiting position (see the solid line in FIG. 2) which is in the upper side, by the tension spring 94c. By contrast, in a state where the clamp roller lifting solenoid 94b is in the on state, the clamp rollers 91 are held to a clamping position (see the broken line in FIG. 2) which is in the lower side, and cooperate with the discharging rollers 82 to clamp a recording sheet (or a recording sheet bundle) on the compile tray 14. At this time, the recording sheet is clamped at an adequate pressure by the plate spring-like clamp roller supporting members 92, and, in accordance with the forward or reverse rotation of the discharging rollers 82, the clamped recording sheet (or recording sheet bundle) is pulled into or discharged from the compile tray 14.

The clamp roller lifting member 94 is not restricted to a combination of the solenoid (94b) and the spring (94c), and may use a configuration where the rollers are lifted or lowered by using, for example, a motor or an eccentric cam. The clamp roller supporting members 92 are not restricted to have the plate spring-like configuration, and may have a configuration where, for example, a clamp roller supporting member which is highly rigid, and a coil spring which presses the clamp roller supporting member toward the discharging rollers 82 are provided.

### (Description of Sub-Paddle 103)

Referring to FIGS. 3 and 12, in a space left below the clamp roller lifting shaft 93, a sub-paddle support shaft 101 is rotatably supported on the frames U4a, U4b. Plural sub-paddle supporting members 102 which rightward extend are fixedly supported by the sub-paddle support shaft 101 with forming a gap in the front and rear direction. A sub-paddle support arm 102a is formed in a right end portion of each of the sub-paddle supporting members 102. A sub-paddle (second sheet end aligning member) 103 which is configured similarly with the main paddles 47, and which conveys a recording sheet on the compile tray 14 toward the main paddles 47 is rotatably supported on the sub-paddle support arm 102a. A pulley 104 is supported on a rotation shaft 103a of the sub-paddle 103. Driving pulleys 105 are rotatably supported on the sub-paddle support shaft 101 at positions corresponding to the pulleys 104. Each of the driving pulleys 105 has a pulley portion 105a and a gear portion 105b. A sub-paddle driving belt SB is attached between the pulley 104 and the pulley portion 105a.

A sub-paddle lifting member 106 which is configured similarly with the clamp roller lifting member 94 is disposed on the rear end of the sub-paddle support shaft 101. The sub-paddle lifting member 106 has a lifting bar 106a, a sub-paddle lifting solenoid 106b, and a tension spring 106c. In accordance with an on/off operation of the sub-paddle lifting solenoid 106b, the sub-paddles 103 are moved between a waiting position (see the solid line in FIG. 3) which is in the upper side, and a sheet pulling position (see the broken line in FIG. 3) in which a recording sheet is pulled toward the main paddles 47, and which is in the lower side.

In FIGS. 12A and 12B, on the left side of the sub-paddle support shaft 101, a sub-paddle driving shaft 111 is swingably supported on the frames U4a, U4b. Driving gears 112 which mesh with the gear portions 105b of the driving pulleys 105 are fixedly supported by the sub-paddle driving shaft 111. Rotation is transmitted to the sub-paddle driving shaft 111 from a post-processing apparatus sheet conveying roller driving motor (not shown) which dives the compile tray discharging roller 13. In accordance with driving of the post-processing apparatus sheet conveying roller driving motor, the rotation is transmitted via the driving gears 112, the gear portions 105b, the pulley portions 105a, the sub-paddle driving belts SB, and the pulleys 104, and the sub-paddles 103 are swung.

In the post-processing apparatus U4 in Example 1, the sub-paddle support shaft 101 and the sub-paddle driving shaft 111 are separately disposed. Another configuration may be employed in which, for example, the sub-paddle supporting members 102 and the driving pulleys 105 are rotatably supported on the clamp roller lifting shaft 93, and a lifting bar which extends in the front and rear direction, and which is movable integrally with the sub-paddle supporting members 102, and a sub-paddle lifting solenoid and tension spring which are coupled to the lifting bar are provided, whereby the sub-paddle support shaft 101 is omitted.

### (Description of Stacker Tray TH1)

Referring to FIGS. 2 and 3, a stacker tray (end-stitching discharging tray) TH1 which receives an aligned sheet bundle or an end-stitched sheet bundle conveyed from the compile tray 14 by the discharging rollers 82 is disposed outward projectingly from the right side wall of the post-processing apparatus U4. The stacker tray TH1 has: a tray guide 121 which is supported on the right side face of the post-processing apparatus U4; a slider 122 which is supported on the tray guide 121 so as to be vertically slidable; and a stacker tray body 123 which is coupled to the slider 122 by screws. The slider 122 and the stacker tray body 123 are configured so as to be vertically moved by a conventionally known lifting mechanism (not shown) (for example, see lifting mechanisms disclosed by JP-A-7-49082, JP-A-7-300270, etc.), and, in accordance with the amount of a recording sheet bundle (the height of the upper face of the sheet bundle) on the stacker tray body 123, vertically moved by means of a sensor which is not shown (for example, JP-A-2003-089463, etc.).

The end-stitching device HTS is configured by the compile tray discharging roller 13, the end-stitching discharging path SH7, the compile tray 14, the sheet side-edge aligning member 33, the sheet rear-end positioning member 41, the main paddles 47, the stapler guide member 61, the movable staple member 70, the discharging rollers 82, the set clamp paddles 83, the shelves 84, the clamp rollers 91, the sub-paddles 103, the stacker tray TH1, etc. The end-stitching device HTS in Example 1 having the above-described configuration executes the end-stitching process, or namely: a sheet waiting process in which the recording sheet S (a first recording sheet S1 which will be described later) is caused to wait in the sheet waiting path SH7c; a sheet conveying process in which the recording sheet S is conveyed onto the compile tray 14; an aligning process in which the rear and side edges of a bundle of the recording sheets S stacked on the compile tray 14 are aligned; a staple process in which the bundle of the recording sheets S that has undergone the aligning process is stitched; and a sheet discharging process in which the bundle of the recording sheets S is discharged from the compile tray 14 to the stacker tray TH1.

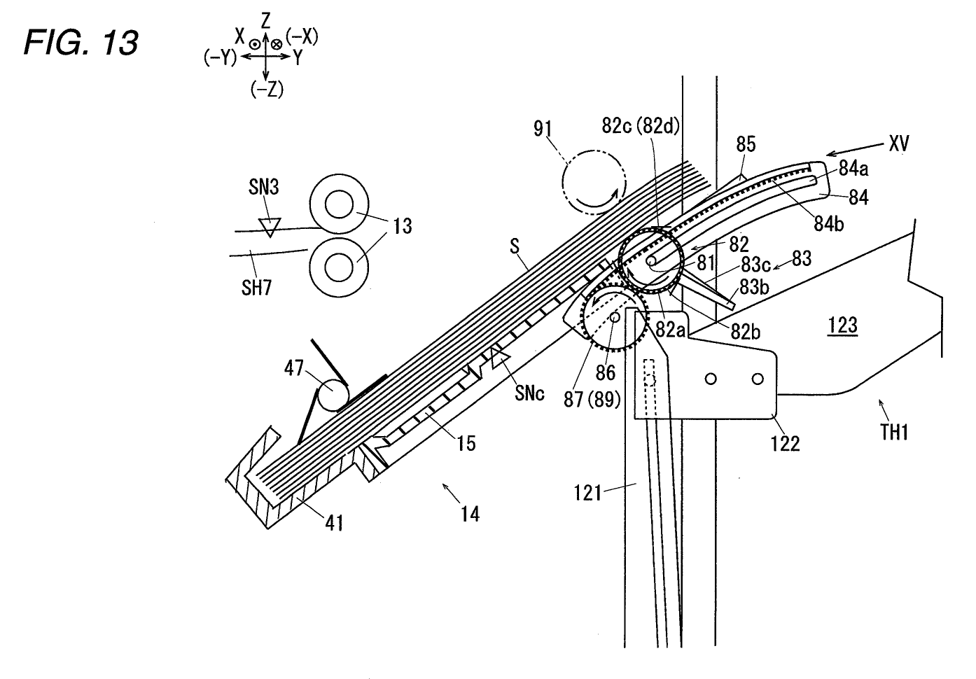

FIG. 13 is a view illustrating a discharging device which discharges sheets stacked on the compile tray to the stacker tray TH1, and showing a state where sheets are stacked on the compile tray.

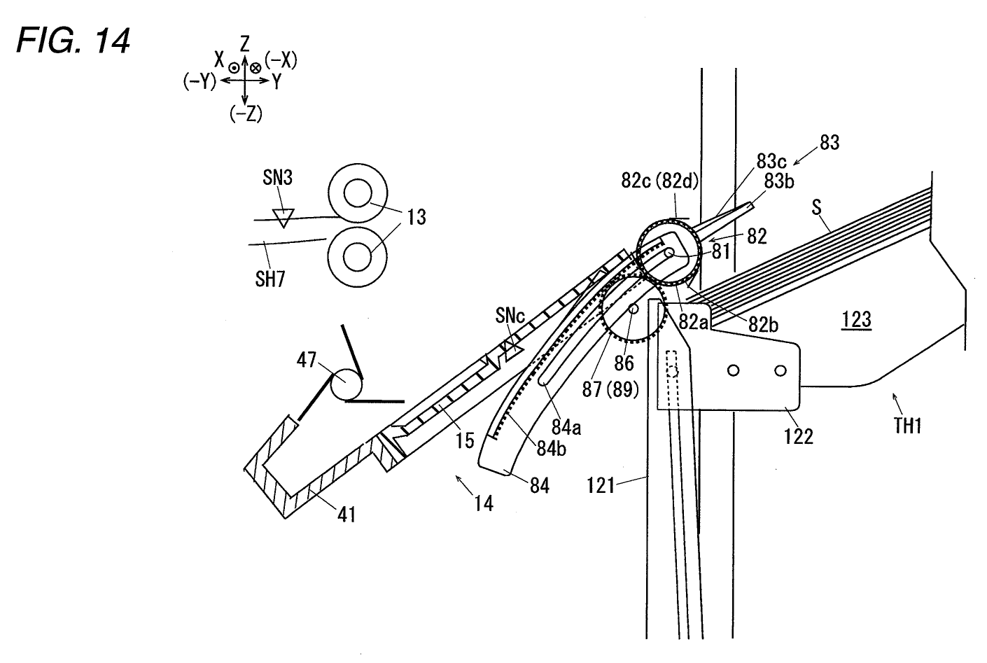

FIG. 14 is a view illustrating the discharging device which discharges sheets stacked on the compile tray to the stacker tray TH1, and showing a state where sheets stacked on the compile tray shown in FIGS. 12A and 12B are discharged to the stacker tray.

In a state where a bundle of plural stacked sheets S is discharged onto the compile tray 14 as shown in FIG. 13, after edges of the sheets are aligned by the tampers 21, 22, or after the stapling work is performed by the movable staple member 70, when a discharge signal instructing that the sheets S on the compile tray 14 are discharged to the stacker tray TH1 is output, the clamp rollers 91 (see FIG. 2) are lowered to press the upper face of the plural sheets S toward the stacker tray discharging rollers 82.

When the stacker tray discharging roller driving motor M4 is forwardly rotated in the state of FIG. 13, the driving shaft 86, the discharging roller driving gears 87, and the shelf operating gears 89 are rotated in the direction of the arrow in FIG. 13. At this time, simultaneously with conveyance from the compile tray 14 toward the stacker tray TH1, the sheets S in a bundle-like form clamped by the clamp rollers 91 and the stacker tray discharging rollers 82 are moved from the sheet lower face supporting position (see FIG. 13) to the housed position (see FIG. 14).

The electromagnetic clutch CL0 (see FIG. 17) is turned on immediately before the completion of discharging of the bundle-like sheets S to the stacker tray TH1, and the set clamp paddles 83 start to swing in a clockwise direction from the clamping position (the position shown in FIG. 13) toward the sheet lower face supporting position (see FIG. 14). At the same time with the completion of discharging of the bundle-like sheets S to the stacker tray TH1, the paddles are swung to the sheet lower face supporting position (see FIG. 14).

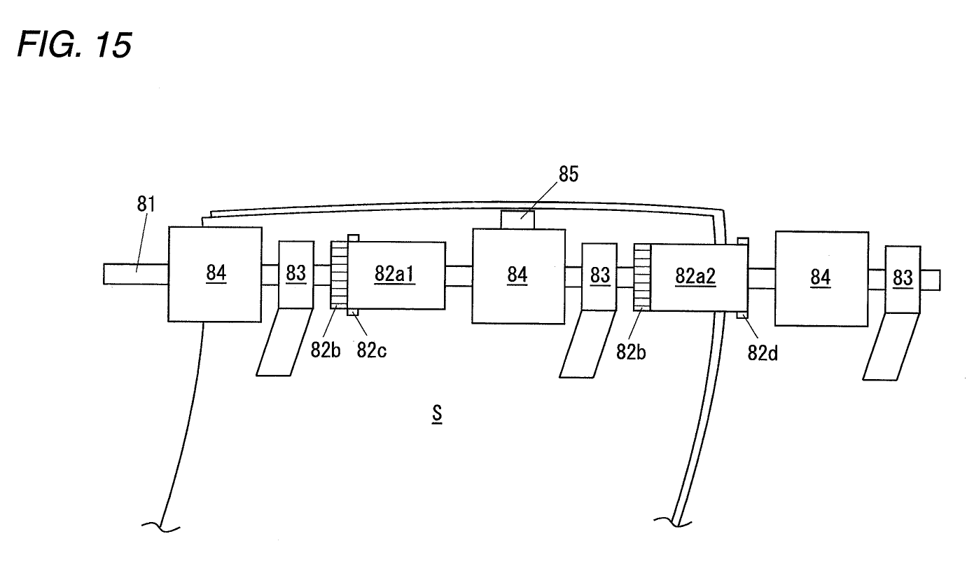

FIG. 15 is a view as seen from the direction of the arrow XV in FIG. 13, and illustrating the members attached to the discharging roller shaft which is rotatably supported.

Referring to FIG. 15, a sheet-like spring member 85 is fixed to the upper face of the center one of the three shelves 84 which are supported on the discharging roller shaft 81 so as to be vertically movable with respect of the discharging roller shaft 81. The sheet-like spring member 85 lifts the sheets S housed in the compile tray 14, and prevents the side edges of the sheets S from, when the sheets S are moved along the direction of the discharging roller shaft 81 by the tamper 21 or 22, and the like, colliding against the side end faces of the shelves 84 and disabling the slide movement.

### (Description of Saddle Stitching Device NTS)

Referring to FIGS. 2 and 3, a saddle stitching device NTS is placed in a lower portion of the saddle stitching discharging path SH8. The device executes a saddle stitching process in which a recording sheet bundle is aligned, a middle portion of the bundle in the sheet conveying direction is stitched, and thereafter the bundle in a state where a middle portion of the bundle is folded is discharged, to a saddle stitching discharge tray TH2. The saddle stitching device NTS is conventionally known (for example, see JP-A-2003-089462, JP-A-2003-089463, and the like), and can employ any of various configurations. Therefore, its detailed description is omitted.

### DESCRIPTION OF CONTROLLING PORTION OF EXAMPLE 1

FIG. 16 is a view showing functions of controlling portions of the image forming apparatus of Example 1 in the form of a block diagram (functional block diagram).

FIG. 17 is a block diagram succeeding FIG. 16.

Referring to FIGS. 16 and 17, a body controller C is configured by a microcomputer having: an I/O (input/output interface) through which signals are input from and output to the outside, and which adjusts levels of input/output signals; a ROM (read-only memory) which stores programs and data for performing necessary processes; a RAM (random access memory) which temporarily stores required data; a CPU (central processing unit) which performs processes according to the programs stored in the ROM; and a clock oscillator. When the programs stored in the ROM are executed, it is possible to realize various functions.

### (Signal Output Elements Connected to Body Controller C)

Output signals of the following signal output elements UI and the like are supplied to the body controller C.

UI: User interface

A user interface UI comprises a display unit UI1, a copy start key UI2, a copy sheet number input key UI3, a numeric keypad UI4, and a post-process setting key UI5 for setting a post-process (“saddle stitching”, “corner stitching”, “side end-stitching”, “no stitching (aligned)”, and “no stitching (not aligned)” to be executed.

### (Controlled Elements Connected to Body Controller C)

The body controller C outputs control signals for the following controlled elements.

### CI: Image Scanner Controller

The image scanner controller CI is a controller which is incorporated in an image scanner of the image inputting device U1 having an automatic document carrying device and the image scanner, and which controls the operation of the image scanner according to the control signal output from the body controller C of the image forming apparatus body U3.

### CG: Document Conveying Device Controller

The document conveying device controller CG is a controller which is incorporated in the automatic document conveying device (not shown) of the image inputting device U1 having the automatic document conveying device and the image scanner, and which controls the operation of the automatic document conveying device according to the control signal output from the body controller C of the image forming apparatus body U3.

### DLy to DLk: Laser Driving Circuit

The laser driving circuits DLy to DLk drive the laser diodes (not shown) of the ROS (latent image forming device) to form electrostatic latent images on the surfaces of the photosensitive members PRy to PRk.

### D0: Main Motor Driving Circuit

A main motor driving circuit D0 drives the main motor M0 to rotate the developing rollers (not shown), the heating roller Fh, the registration roller Rr, Ra of the image carriers PRy to PRk and the developing devices Gy to Gk via gears (not shown).

### E: Power Source Circuit

The power source circuit E has the following power source circuits.

### Ely to Elk: Developing Bias Power Source Circuit

Developing bias power source circuits Ely to Elk apply the developing bias to the developing rollers Ga (not shown) of the developing device Gy to Gk.

E2y to E2k: Charging power source circuit

Charging power source circuits E2y to E2k apply the charge bias to charging rollers CRy to CRk.

E3y to E3k: Primary transfer power source circuit

Primary transfer power source circuits E3y to E3k apply a primary transfer bias to the primary transferring rollers Tly to Tlk.

### E4: Secondary Transfer Power Source Circuit

Secondary transfer power source circuit E4 applies a secondary transfer bias to the secondary transfer contact roller T2c.

### E5: Fixing Power Source Circuit

A fixing power source circuit E5 supplies the heating power to the heating roller Fh.

### (Function of Body Controller C)

The body controller C has programs (function realizing section) which execute processes according to the output signals from the signal output elements, and which output control signals to the control elements. The program (function realizing section) for realizing various functions of the body controller C will be described below.

### C1: Main Motor Rotation Controlling Section

A main motor rotation controlling section C1 controls the main motor driving circuit D1 to control the rotations of the photosensitive members PRy to PRk, the developing roller Ga of the developing device G, the fixing device F, and the like.

### C2: Power Source Circuit Controlling Section

A power source circuit controlling section C2 has the following sections C2a to C2d, and controls the power source circuit E to control the developing bias, the charging bias, the transfer bias, the on/off operations of the heater of the heating roller Fh, and the like.

### C2ay to C2ak: Developing Bias Controlling Section

Developing bias controlling sections C2ay to C2ak control the operations of the developing bias power source circuits Ely to Elk to control the developing biases to be applied to the developing rollers Ga of the developing devices Gy to Gk.

### C2by to C2bk: Charging Bias Controlling Section

Charging bias controlling sections C2by to C2bk control the operations of the charging bias power source circuits E2y to E2k to control the charging bias to be applied to the charging rollers CRy to CRk.

### C2cy to C2ck: Primary Transfer Bias Controlling Section

Primary transfer bias controlling sections C2cy to C2ck control the operations of the transfer power source circuits E3y to E3k to control the transfer biases of the primary transferring rollers Tly to Tlk.

### C2d: Secondary Transfer Bias Controlling Section

A secondary transfer bias controlling section C2d controls the operation of the transfer power source circuit E4 to control the transfer bias to be applied to the secondary transfer contact roller T2c.

### C2e: Fixing Power Source Controlling Section

A fixing power source controlling section C2e controls the operation of the fixing power source circuit E5 to control the on/off operations of the heater of the heating roller Fh.

### C3: Job Controlling Section

A job controlling section C3 controls the operations of the ROS, the image carriers PRy to PRk, the transferring rollers Tly to Tlk, T2c, and the fixing device F according to the input of the copy start key UI2 to execute jobs (the printing operation and the copy operation) which are the image recording operations.

### C4: Post-Process Storing Section

A post-process storing section C4 stores information indicating that the post process set by the input from the user through the post-processing setting key UI5 is one of “saddle stitching”, “corner stitching”, “side end-stitching”, “no stitching (aligned)”, and “no stitching (not aligned)”.

### C5: Stapling/Sheet Discharging Process Execution Number Storing Section

When the post process set by the input from the user through the post-processing setting key UI5 is any one of “corner stitching”, “side end-stitching”, and “no stitching (not aligned)”, a stapling/sheet discharging process execution number storing section C5 stores a stapling/sheet discharging process execution number Na which is a unit number for execution of the stapling process (in the case where “corner stitching” or “side end-stitching” is selected) and the sheet discharging process.

### C6: Copy Sheet Number Storing Section

A copy sheet number storing section C6 stores the number of copy sheets set by the input from the user through the copy sheet number input key UI3.

### (Controlling Section of Post-Processing Apparatus U4)

### CA: Post-Processing Device Controller

A post-processing controller CA is a controller which is incorporated in the finisher (post-processing device) U4, and which controls the operation of the finisher U4 in accordance with the control signal output from the body controller C of the image forming apparatus body U3.

### (Signal Input Elements Connected to Post-Processing Controller CA)

The post-processing device controller CA receives output signals of the following signal input elements.

### SN1: Introducing-Path Sheet Detection Sensor

The introducing-path sheet detection sensor SN1 detects the recording sheet S conveyed through the sheet introducing path SH7a.

### SN2: Waiting-Path Sheet Detection Sensor

The waiting-path sheet detection sensor SN2 detects the recording sheet S conveyed through the sheet waiting path SH7c.

### SN3: Compile Tray Sheet Discharge Sensor

The compile tray sheet discharge sensor SN3 is placed in a downstream end portion of the end-stitching discharging path SH7, and detects passage of the front end of the recording sheet S to be discharged to the compile tray 14.

### SN4: Stapler Position Detection Sensor

A stapler position detection sensor SN4 detects whether the light is blocked (on) by the staple position light-blocking portion 63 or the home position light-blocking portion 64 or not.

### SNc: Compile Tray Sheet Sensor

The compile tray sheet sensor SNc detects whether the sheet S is housed in the compile tray 14 or not.

### (Controlled Elements Connected to Post-Processing Device Controller CA)

The post-processing device controller CA outputs control signals for the following controlled elements.

### DA1: Post-Processing Apparatus Sheet Conveying Roller Driving Circuit

A post-processing apparatus sheet conveying roller driving circuit DA1 controls a post-processing apparatus sheet conveying roller driving motor M5 to drive sheet conveying rollers such as an upper-end discharging roller 4 and the compile tray discharging roller 13.

### DA2: Switching Gate Control Circuit

A switching gate control circuit DA2 controls switching gate operation solenoids SL1, SL2, SL3 to move the switching gates 2 and 3, and the switching gate 12 in the end-stitching discharging path SH7.

### DA3: Rotary Drum Driving Circuit

A rotary drum driving circuit DA3 controls the rotation driving of a rotary drum driving motor M7 to rotate or stop the rotary drum 6.

### DA4: Discharging Roller Driving Circuit

A discharging roller driving circuit DA4 controls the forward and backward rotation of the discharging roller driving motor M4 to rotate the discharging roller 82 forwardly or backwardly or move the shelves 84 between the housed position (see FIG. 3) and the sheet lower face supporting position (see FIG. 2).

### DA5: Set Clamp Paddle Operation Circuit

A set clamp paddle operation circuit DA5 controls the on/off operations of the electromagnetic clutch CL0 to move the set clamp paddles 83 between the sheet clamping position (see FIG. 2) and the sheet lower face supporting position (see FIG. 3).

### DA6: Clamp Roller Lifting Circuit

A clamp roller lifting circuit DA6 controls the on/off operations of the clamp roller lifting solenoid 94b to move the clamp roller 91 between the waiting position and the clamping position.

### DA7: Sub-Paddle Lifting Circuit

A sub-paddle lifting circuit DA7 controls the on/off operations of the sub-paddle lifting solenoid 106b to move the sub-paddles 103 between the waiting position and the sheet pulling position.

### DA8: Sheet End Aligning Member Driving Circuit

A sheet end aligning member driving circuit DA8 controls the rotation driving of a sheet end aligning member driving motor M8 to swing or stop the main paddles 47 and the sub-paddles 103.

### DA9: Tamper Driving Circuit

A tamper driving circuit DA9 controls the forward and backward rotations of the tamper driving motor M1 to cause the tampers 21, 22 to operate.

### DA10: End-Stitching Stapler Moving Circuit

An end-stitching stapler moving circuit DA10 controls the forward and backward rotations of the stapler driving motor M2 to move the carriage 71 and the stapler body 76.

### DA11: End-Stitching Stapler Operation Circuit

An end-stitching stapler operation circuit DA11 controls a cam operation motor M3 to rotate the eccentric cam 79, and punch out the staple needle 77 from the needle punching portion 76a, thereby stitching the sheet bundle.

### DA12: Stacker Tray Operation Circuit

A stacker tray operation circuit DA12 controls the stacker tray operation motor M6 to vertically move the stacker tray TH1.

### DA13: Saddle Stitching Device Control Circuit

A saddle stitching device control circuit DA13 controls control devices for the stapler of the saddle stitching device NTS, and the like to perform the saddle stitching of the recording sheet bundle.

### (Function of Post-Processing Controller CA)

The post-processing controller CA has programs (function realizing section) which execute processes according to the output signals from the signal output elements, and which output control signals to the control elements. The programs (function realizing section) for realizing various functions of the post-processing controller CA will be described below.

### CA1: Post-Processing Determining Section

A post-processing determining section CA1 determines which one of “saddle stitching”, “corner stitching”, “side end-stitching”, “no stitching (aligned)”, and “no stitching (not aligned)” is stored as the post-process in the post-process storing section C4.

### CA2: Discharging-Path Switch Controlling Section

In accordance with the determination result of the post-processing determining section CA1, a discharging-path switch controlling section CA2 controls the switching gates 2, 3 so as to convey the recording sheet S received from the sheet introducing port 1 to the upper-end discharging path SH6 in the case of “no stitching (not aligned)”, the end-stitching discharging path SH7 in the case of “corner stitching”, “side end-stitching”, or “no stitching (aligned)”, or the saddle stitching discharging path SH8 in the case of “saddle stitching”.

### CA3: Post-Processing Device Sheet Conveying Roller Controlling Section

A post-processing device sheet conveying roller controlling section CA3 controls the post-processing apparatus sheet conveying roller driving circuit DA1 in timing with the conveyance of the sheet into the post-processing apparatus U4 to convey the recording sheet S.

### CA4: Sheet Waiting Controlling Section

A sheet waiting controlling section CA4 has: a stapling/sheet discharging process execution determining section CA4a, an end-stitching discharging-path switch controlling section CA4b; and a rotary drum driving controlling section CA4c. In order to prevent the recording sheet S from being discharged to the compile tray 14 during execution of the end-stitching process, the sheet waiting controlling section controls so that the first recording sheet S1 (see FIGS. 4A and 4B) which is scheduled to be discharged to the compile tray 14 waits in the sheet waiting path SH7c until the stapling process or the discharging process is completed. The post-processing apparatus U4 in Example 1 is previously set so that, before a second recording sheet S2 (see FIG. 4B) which is to be conveyed next to the first recording sheet S1 is discharged to the compile tray 14, the stapling process and the discharging process are executed on the bundle of the recording sheets S on the compile tray 14 and the bundle is discharged to the stacker tray TH1.

### CA4a: Stapling/Sheet Discharging Process Execution Determining Section

The end-stitching process execution determining section CA4a determines whether the stapling process or the discharging process is being executed or not. In Example 1, the end-stitching process execution determining section CA4a determines whether a stapling/sheet discharging process execution flag FL2 which will be described later is “1” or not, thereby determining whether the stapling process or the discharging process is being executed or not.

### CA4b: End-Stitching Discharging-Path Switch Controlling Section (Discharging Path Switching Section)

The end-stitching discharging-path switch controlling section CA4b controls the switching gate control circuit DA2 to move the switching gate 12 between the waiting-path conveying position (see FIG. 4A) and the discharging-path conveying position (see FIG. 4B), thereby causing the recording sheet S conveyed to the sheet introducing path SH7a of the end-stitching discharging path SH7 to be conveyed to either of the sheet discharging path SH7b and the sheet waiting path SH7c. At the start of a job, the end-stitching discharging-path switch controlling section CA4b in Example 1 moves the switching gate 12 to the discharging-path conveying position. If the end-stitching process execution determining section CA4a determines that the end-stitching process is being executed, the end-stitching discharging-path switch controlling section CA4b moves the switching gate 12 to the waiting-path conveying position, and, if the waiting-path sheet detection sensor SN2 detects the first recording sheet S1, again moves the switching gate 12 to the discharging-path conveying position.

### CA4c: Rotary Drum Driving Controlling Section

The rotary drum driving controlling section CA4c controls the rotary drum driving circuit DA3 to rotate or stop the rotary drum 6. At the start of a job, the rotary drum driving controlling section CA4c in Example 1 starts the rotation of the rotary drum 6. If the waiting-path sheet detection sensor SN2 detects the first recording sheet S1, the rotary drum driving controlling section CA4c stops the rotation of the rotary drum 6, and, if the introducing-path sheet detection sensor SN1 detects the second recording sheet S2 conveyed through the sheet introducing path SH7a, restarts the rotation of the rotary drum 6.

### CA5: End-Stitching Device Controlling Section

The end-stitching device controlling section CA5 has an end-stitching device controlling timer TM, an end-stitching device controlling timing storing section CA5a, a discharging-roller driving controlling section CA5b, a set clamp paddle operation controlling section CA5c, a clamp roller lifting controlling section CA5d, a sub-paddle lifting controlling section CA5e, a sheet end aligning member driving controlling section CA5f, a tamper controlling section CA5g, an end-stitching stapler moving controlling section CA5h, an end-stitching stapler operation controlling section CA5i, a stacker tray operation controlling section CA5j, and an introduced sheet number counting section CA5k. If the determination result of the post-processing determining section CA1 is one of “corner stitching”, “side end-stitching”, and “no stitching (aligned)”, the end-stitching device controlling section controls the end-stitching device HTS so as to perform the process of end-stitching the bundle of recording sheets S, i.e., a control process (end-stitching process) of the whole end-stitching device HTS in the case where one of “corner stitching”, “side end-stitching”, and “no stitching (aligned)” is selected.

### TM: End-Stitching Device Controlling Timer

The end-stitching device controlling timer TM counts a timing for controlling the end-stitching device HTS. When the discharging rollers 82 are forward rotated by the discharging-roller driving controlling section CA5b which will be described later, and the sheet introducing process of introducing the initial recording sheet S discharged from the compile tray discharging roller 13 is started, the end-stitching device controlling section CA5 in Example 1 starts the time measurement of the end-stitching device controlling timer TM. When, after execution of the stapling operation, the forward rotation of the discharging rollers 82 is again started and the sheet discharging process of discharging the bundle of the recording sheets S on the compile tray 14 to the stacker tray TH1 is started, the end-stitching device controlling section CA5 in Example 1 resets the end-stitching device controlling timer TM to restart the time measurement.

### CA5a: End-Stitching Device Controlling Timing Storing Section

The end-stitching device controlling timing storing section CA5a stores predetermined timings for controlling members of the end-stitching device HTS. In example 1, the end-stitching device controlling timing storing section CA5a stores: a sheet clamping position swing start timing t1 when, after the sheet introducing process is started, the swinging of the set clamp paddles 83 from the sheet lower face supporting position to the sheet clamping position is started during execution of the sheet introducing process; and a sheet clamping position swing end timing t2 when the swinging of the set clamp paddles 83 is ended. The end-stitching device controlling timing storing section CA5a further stores a sheet introducing end timing t3 when, after the sheet introducing process is started, the sheet introducing process is ended.

Moreover, the end-stitching device controlling timing storing section CA5a stores: a rear-end aligning start timing t4 when, after the sheet introducing process is started, the rear-end aligning process of abutting the rear end of the recording sheet S against the rear-end positioning wall 41a of the compile tray 14 is started; a main-puddle reach timing t5 when, during execution of the rear-end aligning process, the rear end of the initial recording sheet S is conveyed to the main paddles 47, and the clamp rollers 91 are lifted; and a rear-end aligning end timing t6 when the rear-end aligning process is ended.

Furthermore, the end-stitching device controlling timing storing section CA5a stores: a sheet lower face supporting position swing start timing t7 when, during execution of the sheet discharging process, the swinging of the set clamp paddles 83 from the sheet clamping position to the sheet lower face supporting position is started; and a sheet lower face supporting position swing end timing t8 when the swinging of the set clamp paddles 83 is ended. The end-stitching device controlling timing storing section CA5a further stores a sheet discharging end timing t9 when, after the sheet discharging process is started, the sheet discharging process is ended.

### CA5b: Discharging-Roller Driving Controlling Section (Discharging-Member Controlling Section)

The discharging-roller driving controlling section CA5b has a sheet introducing start determining section CA5b1, a sheet introducing end determining section CA5b2, a rear-end aligning start determining section CA5b3, a rear-end aligning end determining section CA5b4, a sheet discharging start determining section CA5b5, and a sheet discharging end determining section CA5b6. The discharging-roller driving controlling section controls the discharging roller driving circuit DA4 to cause the discharging roller 82 to rotate forwardly or backwardly, thereby discharging a recording sheet to the stacker tray TH1, or pulling the sheet toward the rear-end positioning wall 41a of the compile tray 14, or moves the shelves 84 between the housed position and the sheet lower face supporting position. In example 1, when the recording sheet bundle aligned or stapled on the compile tray 14 is to be discharged to the stacker tray TH1, the discharging-roller driving controlling section CA5b causes the discharging rollers 82 to be forwardly rotated, so that the bundle of the recording sheets S is discharged, and the shelves 84 are moved to the housed position. When, in a state where there is no sheet on the compile tray 14, the initial recording sheet S is to be discharged to the compile tray 14, the discharging-roller driving controlling section CA5b causes the discharging rollers 82 to be forwardly rotated, and, when the discharged recording sheet S is to be pulled toward the rear-end positioning wall 41a, causes the discharging rollers 82 to be reversely rotated, and moves the shelves 84 to the sheet lower face supporting position.

### CA5b1: Sheet Introducing Start Determining Section

The sheet introducing start determining section CA5b1 determines whether the forward rotation of the discharging rollers 82 is started to start the sheet introducing process or not. In Example 1, the sheet introducing start determining section CA5b1 determines whether the compile tray sheet discharge sensor SN3 detects the initial recording sheet S or not, thereby determining whether the sheet introducing process is started or not.

### CA5b2: Sheet Introducing End Determining Section

The sheet introducing end determining section CA5b2 determines whether the forward rotation of the discharging rollers 82 is stopped to end the sheet introducing process or not. In Example 1, the sheet introducing end determining section CA5b2 determines whether the end-stitching device controlling timer TM counts the sheet introducing end timing t3 stored in the end-stitching device controlling timing storing section CA5a or not, thereby determining whether the sheet introducing process is ended or not.

### CA5b3: Rear-End Aligning Start Determining Section

The rear-end aligning start determining section CA5b3 determines whether the reverse rotation of the discharging rollers 82 is started to start the rear-end aligning process or not. In Example 1, the rear-end aligning start determining section CA5b3 determines whether the end-stitching device controlling timer TM counts the rear-end aligning start timing t4 stored in the end-stitching device controlling timing storing section CA5a or not, thereby determining whether the rear-end aligning process is started or not.

### CA5b4: Rear-End Aligning End Determining Section

The rear-end aligning end determining section CA5b4 determines whether the reverse rotation of the discharging rollers 82 is stopped to end the rear-end aligning process or not. In Example 1, the rear-end aligning end determining section CA5b4 determines whether the end-stitching device controlling timer TM counts the rear-end aligning end timing t6 stored in the end-stitching device controlling timing storing section CA5a or not, thereby determining whether the rear-end aligning process is ended or not.

### CA5b5: Sheet Discharging Start Determining Section

The sheet discharging start determining section CA5b5 determines whether the sheet discharging process of discharging a bundle of the recording sheets S on the compile tray 14 to the stacker tray TH1 is started or not. In Example 1, the sheet discharging start determining section CA5b5 determines whether the stapling operation executed by the end-stitching device controlling section CA5 is ended or not, thereby determining whether the sheet discharging process is started or not. In the case where “corner stitching” or “side end-stitching” is selected, the bundle of the recording sheets S is aligned, and determination on whether the stapling operation (“corner stitching” or “side end-stitching”) is completed or not is performed, thereby determining whether the sheet discharging process is started or not. In the case where “no stitching (aligned)” is selected, determination on whether the bundle of the recording sheets S is aligned or not is performed, thereby determining whether the sheet discharging process is started or not.

### CA5b6: Sheet Discharging End Determining Section

The sheet discharging end determining section CA5b6 determines whether the forward rotation of the discharging rollers 82 is stopped to end the sheet discharging process or not. In Example 1, the sheet discharging end determining section CA5b6 determines whether the end-stitching device controlling timer TM counts the sheet discharging end timing t9 stored in the end-stitching device controlling timing storing section CA5a or not, thereby determining whether the sheet discharging process is ended or not.

### CA5c: Set Clamp Paddle Operation Controlling Section

The set clamp paddle operation controlling section CA5c has a sheet clamping position swing start determining section CA5c1, a sheet clamping position swing end determining section CA5c2, a sheet lower face supporting position swing start determining section CA5c3, and a sheet lower face supporting position swing end determining section CA5c4. The set clamp paddle operation controlling section controls the on/off operations of the electromagnetic clutch CL0 via the set clamp paddle operation circuit DA5, to move the set clamp paddles 83 between the sheet clamping position (see FIG. 2) and the sheet lower face supporting position (see FIG. 3). In Example 1, in a state where the shelves 84 are moved to the sheet lower face supporting position, the set clamp paddle operation controlling section CA5c holds the set clamp paddles 83 to the sheet clamping position. Then, the sheet discharging process is executed, and the set clamp paddles 83 are moved to the sheet lower face supporting position in accordance with a timing when the rear end of the recording sheet bundle discharged to the stacker tray TH1 is passed over the discharging rollers 82. After the sheet bundle is discharged, the next one recording sheet is introduced into the compile tray 14, and the set clamp paddles 83 are moved to the sheet clamping position in accordance with a timing when the recording sheet is pulled toward the main paddles 47.

### CA5c1: Sheet Clamping Position Swing Start Determining Section

The sheet clamping position swing start determining section CA5c1 determines whether, during execution of the sheet introducing process, the swinging of the set clamp paddles 83 from the sheet lower face supporting position to the sheet clamping position is started or not. In Example 1, the sheet clamping position swing start determining section CA5c1 determines whether the end-stitching device controlling timer TM counts the sheet clamping position swing start timing t1 stored in the end-stitching device controlling timing storing section CA5a or not, thereby determining whether the swinging of the set clamp paddles 83 is started or not.

### CA5c2: Sheet Clamping Position Swing End Determining Section

The sheet clamping position swing end determining section CA5c2 determines whether the swinging of the set clamp paddles 83 is ended or not. In Example 1, the sheet clamping position swing end determining section CA5c2 determines whether the end-stitching device controlling timer TM counts the sheet clamping position swing end timing t2 stored in the end-stitching device controlling timing storing section CA5a or not, thereby determining whether the swinging of the set clamp paddles 83 is ended or not.

### CA5c3: Sheet Lower Face Supporting Position Swing Start Determining Section

The sheet lower face supporting position swing start determining section CA5c3 determines whether, during execution of the sheet discharging process, the swinging of the set clamp paddles 83 from the sheet clamping position to the sheet lower face supporting position is started or not. In Example 1, the sheet lower face supporting position swing start determining section CA5c3 determines whether the end-stitching device controlling timer TM counts the sheet lower face supporting position swing start timing t7 stored in the end-stitching device controlling timing storing section CA5a or not, thereby determining whether the swinging of the set clamp paddles 83 is started or not.

### CA5c4: Sheet Lower Face Supporting Position Swing End Determining Section

The sheet lower face supporting position swing end determining section CA5c4 determines whether the swinging of the set clamp paddles 83 is ended or not. In Example 1, the sheet lower face supporting position swing end determining section CA5c4 determines whether the end-stitching device controlling timer TM counts the sheet lower face supporting position swing end timing t8 stored in the end-stitching device controlling timing storing section CA5a or not, thereby determining whether the swinging of the set clamp paddles 83 is ended or not.

### CA5d: Clamp Roller Lifting Controlling Section

The clamp roller lifting controlling section CA5d has a main-puddle reach determining section CA5d1, and controls the on/off operations of the clamp roller lifting solenoid 94b via the clamp roller lifting circuit DA6, to move the clamp rollers 91 between the waiting position and the clamping position in accordance with the timings of the sheet discharging process and the rear-end aligning process.

### CA5d1: Main-Puddle Reach Determining Section

The main-puddle reach determining section CA5d1 determines whether, during execution of the rear-end aligning process, the rear end of the initial recording sheet S is conveyed to the main paddles 47 or not. In Example 1, the main-puddle reach determining section CA5d1 determines whether the end-stitching device controlling timer TM counts the main-puddle reach timing t5 or not, thereby determining whether the rear end of the initial recording sheet S is conveyed to the main paddles 47 to reach a timing when the clamp rollers 91 are moved from the clamping position to the waiting position or not.

### CA5e: Sub-Paddle Lifting Controlling Section (Second-Sheet End Aligning Member Controlling Section)

The sub-paddle lifting controlling section CA5e has a main-paddle reach determining section CA5e1, and controls the on/off operations of the sub-paddle lifting solenoid 106b via the sub-paddle lifting circuit DA7, to move the sub-paddles 103 between the waiting position and the sheet pulling position in accordance with the timing when the recording sheet S is introduced into the compile tray 14.

### CA5e1: Main-Paddle Reach Determining Section

The main-paddle reach determining section CA5e1 determines whether, during execution of the rear-end aligning process, the rear end of the recording sheet S which is detected at a second or subsequent time by the compile tray sheet discharge sensor SN3 is conveyed to the main paddles 47 or not. In Example 1, the main-paddle reach determining section CA5e1 determines whether, after the sub-paddles 103 are moved (lowered) from the waiting position to the sheet pulling position, a predetermined timing when the recording sheet S which is conveyed by the sub-paddles 103 reaches the main paddles 47 has elapsed or not, thereby determining whether it is a timing when the rear end of the recording sheet S has been conveyed to the main paddles 47 and the sub-paddles 103 are to be moved from the sheet pulling position to the waiting position.

### CA5f: Sheet End Aligning Member Driving Controlling Section

The sheet end aligning member driving controlling section CA5f controls the rotation driving of the sheet end aligning member driving motor M8 via the sheet end aligning member driving circuit DA8, to swing or stop the main paddles 47 and the sub-paddles 103.

### CA5g: Tamper Controlling Section

In accordance with the size of the recording sheet S introduced to the compile tray 14, the tamper controlling section CA5g controls the rotation driving of the tamper driving motor M1 via the tamper driving circuit DA9, to cause the tampers 21, 22 to operate, thereby aligning the side edges of recording sheets S conveyed to the compile tray 14. In Example 1, each time when one recording sheet S is introduced into the compile tray 14, the tamper controlling section CA5g causes the tampers 21, 22 to operate, thereby aligning the side edges of the recording sheets S.

### CA5h: End-Stitching Stapler Moving Controlling Section

The end-stitching stapler moving controlling section CA5h controls the rotation driving of the stapler driving motor M2 via the end-stitching stapler moving circuit DA10, to move the movable staple member 70 to the home position (the reference position and a corner stitching position, see the dash-dot line in FIG. 6) and the staple positions (side end-stitching positions, see the solid line or the dash-dot-dot line in FIG. 6). In Example 1, during execution of “corner stitching” or “side end-stitching”, the end-stitching stapler moving controlling section CA5h moves the movable staple member 70 to a position corresponding to the stitching position.

### CA5i: End-Stitching Stapler Operation Controlling Section

The end-stitching stapler operation controlling section CA5i controls the rotation driving of the cam operation motor M3 via the end-stitching stapler operation circuit DA11, to rotate the eccentric cam 79 to punch out the staple needle 77 from the needle punching portion 76a, thereby stitching the bundle of the recording sheets S.

### CA5j: Stacker Tray Operation Controlling Section

The stacker tray operation controlling section CA5j controls the driving of the stacker tray operation motor M6 via the stacker tray operation circuit DA12, to vertically move the stacker tray TH1 in accordance with the amount of the recording sheets S stacked on the stacker tray TH1.

### CA5k: Introduced Sheet Number Counting Section

The introduced sheet number counting section CA5k has a sheet waiting process execution determining section CA5k1, and counts a compile tray introduction number n which is equal to the number of the recording sheets S introduced into the compile tray 14. In Example 1, if the compile tray sheet discharge sensor SN3 detects the recording sheet S, the introduced sheet number counting section CA5k increments the compile tray introduction number n. Specifically, in the case where the sheet waiting process in which the first recording sheet S1 is caused to wait in the sheet waiting path SH7c is executed, the first and second recording sheets S1, S2 in a state where the two sheets overlap each other are conveyed to the sheet discharging path SH7b, and the sheets are detected by the compile tray sheet discharge sensor SN3, the introduced sheet number counting section CA5k adds +2 to the compile tray introduction number n. In a case other than the above, namely, in the case where the recording sheet S is conveyed one by one to the sheet discharging path SH7b, and the recording sheet is detected by the compile tray sheet discharge sensor SN3, the introduced sheet number counting section CA5k adds +1 to the compile tray introduction number n. When the sheet discharging process is executed, the compile tray introduction number n is initialized to 0.

### CA5k1: Sheet Waiting Process Execution Determining Section

The sheet waiting process execution determining section CA5k1 determines whether the sheet waiting process has been executed or not. Specifically, the sheet waiting process execution determining section CA5k1 determines whether a sheet waiting process execution flag FL1 which will be described later is “1” or not, thereby determining whether the sheet waiting process has been executed or not.

### CA6: Saddle Stitching Device Controlling Section

When “saddle stitching” is designated by a user input through the post-processing setting key UI5 of the user interface UI, a saddle stitching device controlling section CA6 controls the saddle stitching device control circuit DA13 to allow the saddle stitching device NTS to perform saddle stitching on the recording sheet bundle.

### FL1: Sheet Waiting Process Execution Flag

The sheet waiting process execution flag FL1 has an initial value of “0”. When the sheet waiting process is started, the flag is changed to “1”, and, when the sheet waiting process is ended and the recording sheets S1, S2 are detected by the compile tray sheet discharge sensor SN3, the flag is changed to “0”.

### FL2: Stapling/Sheet Discharging Process Execution Flag

The stapling/sheet discharging process execution flag FL2 has an initial value of “0”. When the stapling process or the sheet discharging process is started, the flag is changed to “1”, and, when the sheet discharging process is ended, the flag is changed to “0”.

### DESCRIPTION OF FLOWCHART OF EXAMPLE 1

Next, the flow of the process of the image forming apparatus U of Example 1 of the invention will be described with reference to the flowcharts.

### DESCRIPTION OF FLOWCHART OF SHEET WAITING PROCESS IN EXAMPLE 1

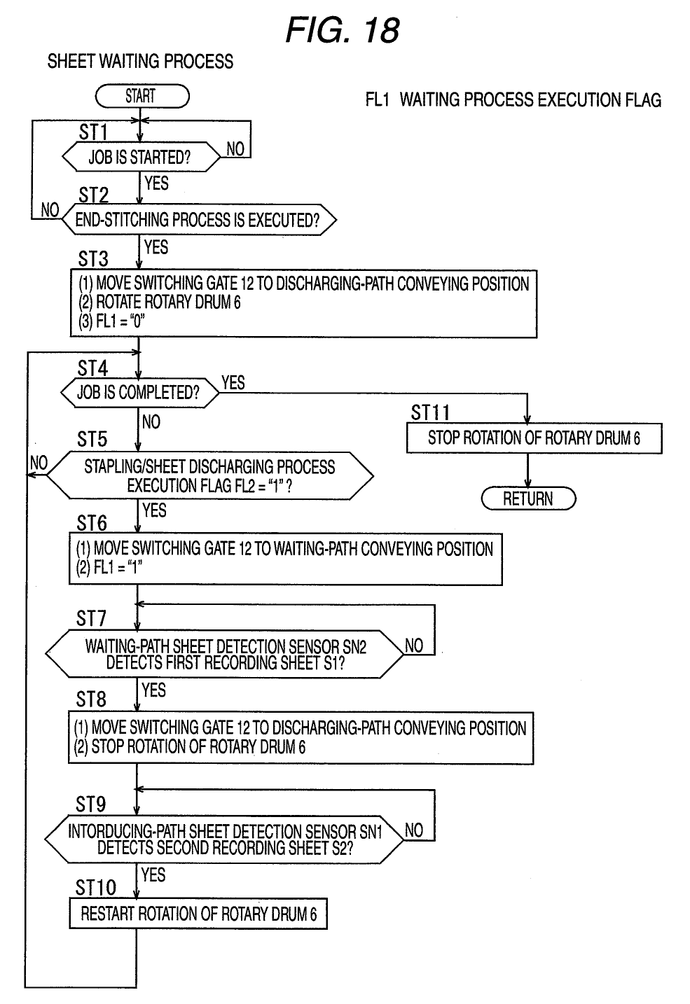

FIG. 18 is a flowchart of the sheet waiting process in the end-stitching discharging path of the post-processing apparatus of the invention.

The process of each ST (step) in the flowchart of FIG. 18 is performed in accordance with the programs stored in the ROM of the post-processing controller CA. The process is performed in a multitask manner in parallel with other various processes of the image forming apparatus.

The flowchart shown in FIG. 18 is started by turning on a power source of the image forming apparatus U.

In ST1 of FIG. 18, it is checked whether the job is started or not. If yes (Y), the process proceeds to ST2, and, if no (N), ST1 is repeated.

In ST2, it is checked whether the post process set by the input from the user through the post-processing setting key UI5 is one of “corner stitching”, “side end-stitching”, and “no stitching (aligned)” or not, thereby determining whether the end-stitching process in which the end-stitching device HTS is controlled is to be performed or not. If yes (Y), the process proceeds to ST3, and, if no (N), the process returns to ST1.

In ST3, following processes (1) to (3) are executed, and then the process proceeds to ST4.
(1) The switching gate 12 is moved to the discharging-path conveying position.
(2) The rotation of the rotary drum 6 is started.
(3) The sheet waiting process execution flag FL1 is initialized to “0” (FL1=“0”).

In ST4, it is checked whether the job is completed or not. If yes (Y), the process proceeds to ST5, and, if no (N), the process proceeds to ST11.

In ST5, it is checked whether the stapling/sheet discharging process execution flag FL2 is “1” or not. Namely, it is checked whether the stapling process or the sheet discharging process is being executed or not. If yes (Y), the process proceeds to ST6, and, if no (N), the process returns to ST4.

In ST6, following processes (1) and (2) are executed, and then the process proceeds to ST7.
(1) The switching gate 12 is moved to the waiting-path conveying position.
(2) The waiting process execution flag FL1 is set to “1” (FL1=“1”).

In ST7, it is checked whether the waiting-path sheet detection sensor SN2 detects the first recording sheet S1 (see FIGS. 4A and 4B) conveyed to the sheet waiting path SH7c or not. If yes (Y), the process proceeds to ST8, and, if no (N), ST7 is repeated.

In ST8, following processes (1) and (2) are executed, and then the process proceeds to ST9.
(1) The switching gate 12 is moved to the discharging-path conveying position.
(2) The rotation of the rotary drum 6 is stopped.

In ST9, it is checked whether the introducing-path sheet detection sensor SN1 detects the second recording sheet S2 (see FIG. 4B) conveyed to the sheet introducing path SH7a or not. If yes (Y), the process proceeds to ST10, and, if no (N), ST9 is repeated.

In ST10, the rotation of the rotary drum 6 is restarted, and then the process returns to ST4.

In ST11, the rotation of the rotary drum 6 is stopped, and then the process returns to ST1.

### DESCRIPTION OF FLOWCHART OF END-STITCHING DEVICES HTS IN EXAMPLE 1

Next, the flows of various processes executed by the end-stitching device controlling section CA5 which controls the end-stitching device HTS in Example 1 of the invention will be described with reference to the flowcharts.

In the process of controlling the tampers 21, 22, only the process of causing the tampers 21, 22 to approach each other each time when one recording sheet S is introduced into the compile tray 14, then separating the tampers from each other, and aligning the side edges of the recording sheets S is repeatedly executed. Therefore, illustration of the process by means of a flowchart, and detailed description of the process are omitted. In the process of lifting the stacker tray TH1, only the process of vertically moving the stacker tray TH1 in accordance with the amount of the recording sheets S stacked on the stacker tray TH1 is executed. Similarly, therefore, illustration of the process by means of a flowchart, and detailed description of the process are omitted.

### DESCRIPTION OF FLOWCHART OF END-STITCHING DEVICE CONTROLLING PROCESS IN EXAMPLE 1

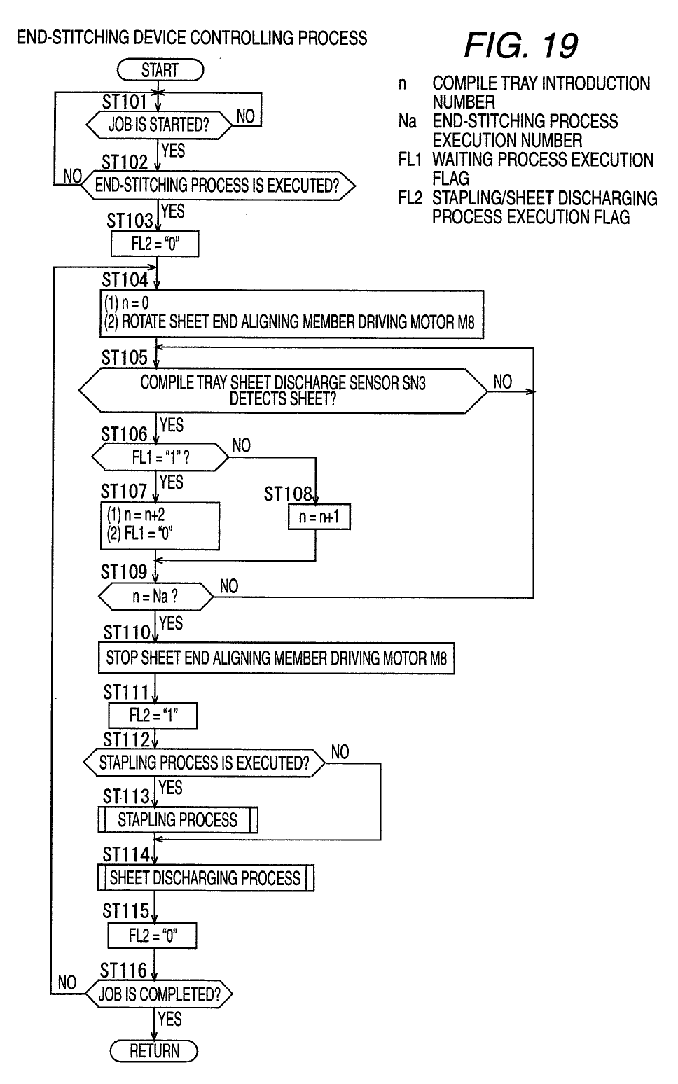

FIG. 19 is a flowchart of the end-stitching device controlling process in the end-stitching device of the post-processing apparatus of the invention.

The process of each ST (step) in the flowchart of FIG. 19 is performed in accordance with the programs stored in the ROM of the post-processing controller CA. The process is performed in a multitask manner in parallel with other various processes of the image forming apparatus.

The flowchart shown in FIG. 19 is started by turning on the power source of the image forming apparatus U.

In ST101 of FIG. 19, it is checked whether the job is started or not. If yes (Y), the process proceeds to ST102, and, if no (N), ST101 is repeated.

In ST102, it is checked whether the post process set by the input from the user through the post-processing setting key UI5 is one of “corner stitching”, “side end-stitching”, and “no stitching (aligned)” or not, thereby determining whether the end-stitching process in which the end-stitching device HTS is controlled is to be performed or not. If yes (Y), the process proceeds to ST103, and, if no (N), the process returns to ST101.

In ST103, the stapling/sheet discharging process execution flag FL2 is initialized to “0” (FL2=“0”). Then, the process proceeds to ST104.

In ST104, following processes (1) and (2) are executed, and then the process proceeds to ST105.
(1) The compile tray introduction number n is initialized to 0 (n=0).
(2) The rotation driving of the sheet end aligning member driving motor M8 is started to start the swinging of the main paddles 47 and the sub-paddles 103.

In ST105, it is checked whether the compile tray sheet discharge sensor SN3 detects the recording sheet S introduced to the compile tray 14 or not. If yes (Y), the process proceeds to ST106, and, if no (N), ST105 is repeated.

In ST106, it is checked whether the waiting process execution flag FL1 is “1” or not. Namely, it is checked whether the sheet waiting process is executed and the first and second recording sheets S1, S2 are introduced in a state where the two sheets overlap each other or not. If yes (Y), the process proceeds to ST107, and, if no (N), the process proceeds to ST108.

In ST107, following processes (1) and (2) are executed, and then the process proceeds to ST109.
(1) The compile tray introduction number n is added with +2 (n=n+2).
(2) The waiting process execution flag FL1 is set to “0” (FL1=“0”).

In ST108, +1 is added to the compile tray introduction number n (n=n+1), and then the process proceeds to ST109.

In ST109, it is checked whether the counted value of the compile tray introduction number n reaches an end-stitching process execution number Na (n=Na) or not. Namely, it is checked whether all of the bundle of the recording sheets S to be end-stitched is stacked on the compile tray 14 or not. If no (N), the process proceeds to ST110, and, if yes (Y), the process returns to ST105.

In ST110, the rotation driving of the sheet end aligning member driving motor M8 is stopped, and the swinging of the main paddles 47 and the sub-paddles 103 is stopped. Then, the process proceeds to ST111.

In ST111, the stapling/sheet discharging process execution flag FL2 is set to “1” (FL2=“1”). Then, the process proceeds to ST112.

In ST112, it is checked whether the post process set by the input from the user through the post-processing setting key UI5 is one of “corner stitching” and “side end-stitching” or not, thereby determining whether the stapling process is to be performed or not. If yes (Y), the process proceeds to ST113, and, if no (N), the process proceeds to ST114.

In ST113, the stapling process (“corner stitching” or “side end-stitching”) is executed on the bundle of the aligned recording sheets S. In the case where “corner stitching” or “side end-stitching” is selected in the end-stitching process of ST21, the movable staple member 70 is moved to a position corresponding to the stitching position, and the eccentric cam 79 is rotated to punch out the staple needle 77 from the needle punching portion 76a, thereby stitching the bundle of the aligned recording sheets S. Then, the process proceeds to ST114.

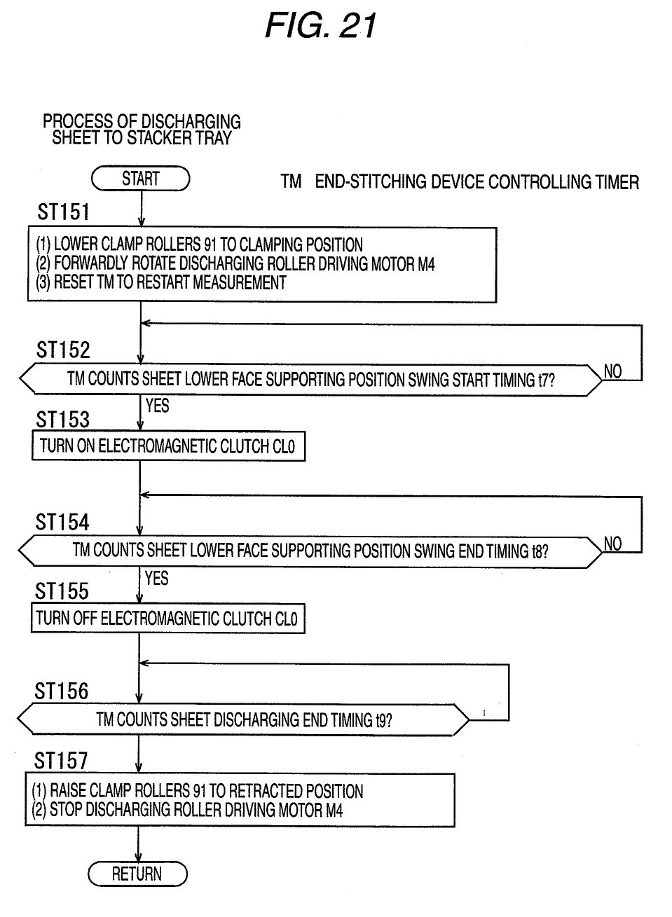

In ST114, the sheet discharging process (see the flowchart of FIG. 21 which will be described later) of discharging the bundle of the recording sheets S on the compile tray 14 is executed. Then, the process proceeds to ST115.

In ST115, the stapling/sheet discharging process execution flag FL2 is set to “0” (FL2=“0”). Then, the process proceeds to ST116.

In ST116, it is checked whether the job is completed or not. If yes (Y), the process returns to ST101, and, if no (N), the process returns to ST104.

### DESCRIPTION OF FLOWCHART OF REAR-END ALIGNING PROCESS IN EXAMPLE 1

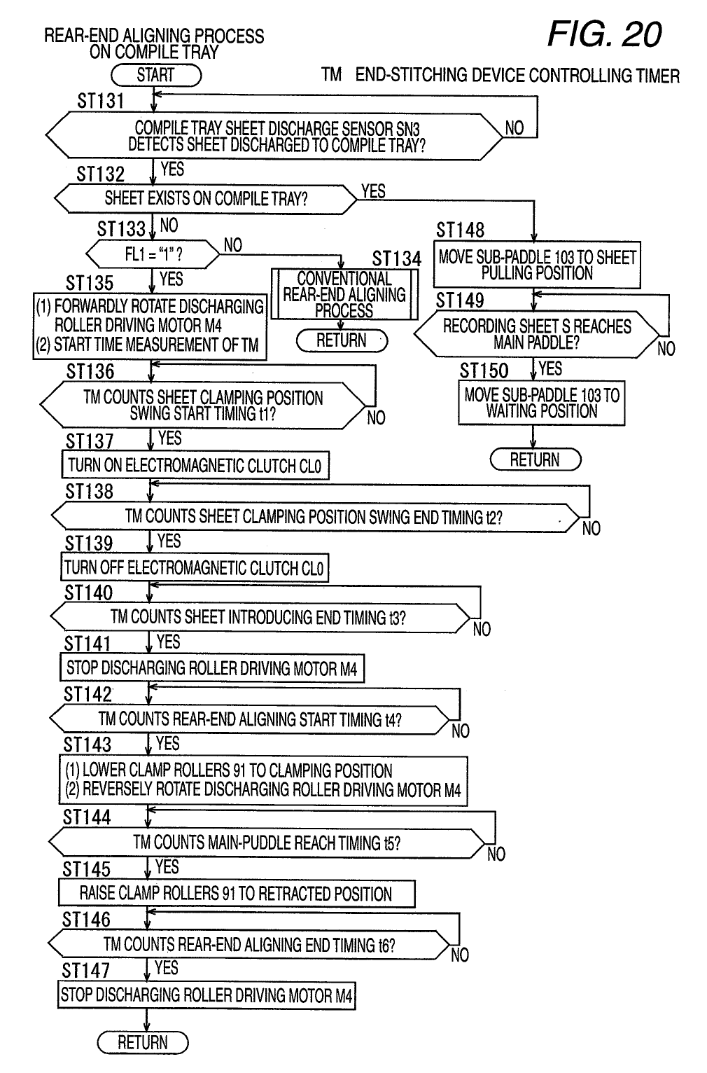

FIG. 20 is a flowchart of the rear-end aligning process in the end-stitching device of the post-processing apparatus of the invention.

The process of each ST (step) in the flowchart of FIG. 20 is performed in accordance with the programs stored in the ROM of the post-processing controller CA. The process is performed in a multitask manner in parallel with other various processes of the image forming apparatus.

The flowchart shown in FIG. 20 is started by turning on the power source of the image forming apparatus U.

In ST131 of FIG. 20, it is checked whether the compile tray sheet discharge sensor SN3 detects the recording sheet S introduced to the compile tray 14 or not. If yes (Y), the process proceeds to ST132, and, if no (N), ST131 is repeated.

In ST132, it is checked whether the compile tray sheet sensor SNc detects the recording sheets S (bundle of the recording sheets S) stacked on the compile tray 14 or not. If no (N), the process proceeds to ST133, and, if yes (Y), the process proceeds to ST148.

In ST133, it is checked whether the waiting process execution flag FL1 is “1” or not. Namely, it is checked whether the sheet waiting process is executed and the first and second recording sheets S1, S2 are introduced in a state where the two sheets overlap each other or not. If no (N), the process proceeds to ST134, and, if yes (Y), the process proceeds to ST135.

In ST134, a conventionally known rear-end aligning process (for example, see ST3 to ST11 in FIG. 18 of JP-A-2006-69746) is executed in which the discharging rollers 82 are rotated, the recording sheet S that is initially stacked on the compile tray 14 is conveyed to the main paddles 47 by the discharging rollers 82, the discharging rollers 82 are stopped when the rear end of the recording sheet S reaches the main paddles 47, and the main paddles 47 butts the end against the rear-end positioning wall 41a to align the rear end. Thereafter, the process returns to ST131.

In ST135, following processes (1) and (2) are executed, and then the process proceeds to ST136.
(1) The discharging roller driving motor M4 is forwardly rotated.
(2) The time measurement of the end-stitching device controlling timer TM is started.

In ST136, it is checked whether the end-stitching device controlling timer TM counts the sheet clamping position swing start timing t1 or not. If yes (Y), the process proceeds to ST137, and, if no (N), ST136 is repeated.

In ST137, the electromagnetic clutch CL0 is turned on, and the swinging of the set clamp paddles 83 from the sheet lower face supporting position to the sheet clamping position is started. Then, the process proceeds to ST138.

In ST138, it is checked whether the end-stitching device controlling timer TM counts the sheet clamping position swing end timing t2 or not. If yes (Y), the process proceeds to ST139, and, if no (N), ST138 is repeated.

In ST139, the electromagnetic clutch CL0 is turned off, and the swinging of the set clamp paddles 83 is stopped. Then, the process proceeds to ST140.

In ST140, it is checked whether the end-stitching device controlling timer TM counts the sheet introducing end timing t3 or not. If yes (Y), the process proceeds to ST141, and, if no (N), ST140 is repeated.

In ST141, the rotation of the discharging roller driving motor M4 is stopped. Then, the process proceeds to ST142.

In ST142, it is checked whether the end-stitching device controlling timer TM counts the rear-end aligning start timing t4 or not. If yes (Y), the process proceeds to ST143, and, if no (N), ST142 is repeated.

In ST143, following processes (1) and (2) are executed, and then the process proceeds to ST144.
(1) The clamp roller lifting solenoid 94b is turned on, and the clamp rollers 91 are moved from the waiting position to the clamping position.
(2) The discharging roller driving motor M4 is reversely rotated.

In ST144, it is checked whether the end-stitching device controlling timer TM counts the main-puddle reach timing t5 or not. If yes (Y), the process proceeds to ST145, and, if no (N), ST144 is repeated.

In ST145, the clamp roller lifting solenoid 94b is turned off, and the clamp rollers 91 are moved from the clamping position to the waiting position. Then, the process proceeds to ST146.

In ST146, it is checked whether the end-stitching device controlling timer TM counts the rear-end aligning end timing t6 or not. If yes (Y), the process proceeds to ST147, and, if no (N), ST146 is repeated.

In ST147, the rotation of the discharging roller driving motor M4 is stopped. Then, the process returns to ST131.

In ST148, the sub-paddle lifting solenoid 106b is turned on, and the sub-paddles 103 are moved (lowered) from the waiting position to the sheet pulling position. Then, the process proceeds to ST149.

In ST149, it is checked whether a predetermined timing when the recording sheet S is conveyed (pulled) to the main paddles 47 is counted or not. If yes (Y), the process proceeds to ST150, and, if no (N), ST149 is repeated.

In ST150, the sub-paddle lifting solenoid 106b is turned off, and the sub-paddles 103 are moved from the sheet pulling position to the waiting position. Thereafter, the process returns to ST131.

### DESCRIPTION OF SHEET DISCHARGING PROCESS (SUBROUTINE IN ST23) IN EXAMPLE 1

FIG. 21 is a flowchart of the sheet discharging process in the end-stitching device of the post-processing apparatus of the invention, and illustrating the subroutine in ST113 of FIG. 19.

In ST151 of FIG. 21, following processes (1) to (3) are executed, and then the process proceeds to ST152.
(1) The clamp roller lifting solenoid 94b is turned on, and the clamp rollers 91 are moved from the waiting position to the clamping position.
(2) The discharging roller driving motor M4 is forwardly rotated.
(3) The end-stitching device controlling timer TM is reset to restart the counting.

In ST152, it is checked whether the end-stitching device controlling timer TM counts the sheet lower face supporting position swing start timing t7 or not. If yes (Y), the process proceeds to ST153, and, if no (N), ST152 is repeated.

In ST153, the electromagnetic clutch CL0 is turned on, and the swinging of the set clamp paddles 83 from the sheet clamping position to the sheet lower face supporting position is started. Then, the process proceeds to ST154.

In ST154, it is checked whether the end-stitching device controlling timer TM counts the sheet lower face supporting position swing end timing t8 or not. If yes (Y), the process proceeds to ST155, and, if no (N), ST154 is repeated.

In ST155, the electromagnetic clutch CL0 is turned off, and the swinging of the set clamp paddles 83 is stopped. Then, the process proceeds to ST156.

In ST156, it is checked whether the end-stitching device controlling timer TM counts the sheet discharging end timing t9 or not. If yes (Y), the process proceeds to ST157, and, if no (N), ST156 is repeated.

In ST157, following processes (1) and (2) are executed, the sheet discharging process is ended, and the process returns to the end-stitching device controlling process in ST23 of FIG. 19.
(1) The clamp roller lifting solenoid 94b is turned off, and the clamp rollers 91 are moved from the clamping position to the waiting position.
(2) The rotation of the discharging roller driving motor M4 is stopped.

### FUNCTION OF EXAMPLE 1

In the thus configured post-processing apparatus U4 of Example 1, in the sheet waiting path SH7c, the rotary drum 6 is rotated simultaneously with the start of the end-stitching process, and the recording sheet S is discharged to and stacked on the compile tray 14 (see (2) of ST1, ST2, and ST3 of FIG. 18). If it is determined that, during execution of the stapling process (see ST113 of FIG. 19) or the sheet discharging process (see ST114 of FIG. 19, and ST151 to ST157 of FIG. 21) on the bundle of the recording sheets S stacked on the compile tray 14, the next recording sheet S (first recording sheet S1) is conveyed (see ST5 of FIG. 18), the switching gate 12 is moved from the discharging-path conveying position (see FIG. 4B) to the waiting-path conveying position (see FIG. 4A), and the first recording sheet S1 is introduced into the sheet waiting path SH7c (see FIG. 4A and ST6 of FIG. 18). In the case where the waiting-path sheet detection sensor SN2 detects the front end of the first recording sheet S1 introduced into the sheet waiting path SH7c (see ST7 of FIG. 18), the rotary drum 6 is stopped, and the switching gate 12 is moved from the waiting-path conveying position to the discharging-path conveying position (see FIG. 4B and ST8 of FIG. 18).

In the case where the introducing-path sheet detection sensor SN1 detects that the next recording sheet (second recording sheet S2) is introduced into the sheet introducing path SH7a (see ST9 of FIG. 18), the rotation of the rotary drum 6 is restarted, and the first and second recording sheets S1, S2 join each other at the joining position. The joined two or first and second recording sheets S1, S2 are simultaneously discharged in an overlapping manner to the compile tray 14 in a state where the upper face of the first recording sheet S1 is contacted with the lower face of the second recording sheet S2 (see ST10 of FIG. 18).

In the post-processing apparatus U4 of Example 1, therefore, the first recording sheet S1 can wait in the waiting path during the stapling process, and hence it is not required to stop the printing operation (image forming operation) on the first recording sheet S1 in order to prevent the first recording sheet S from being introduced during the stapling process. In the post-processing apparatus U4 of Example 1, as a result, the execution of the sheet waiting process (see the flowchart of FIG. 18) on the first recording sheet S1 enables the image forming operation and the post process to be efficiently performed, and the productivity to be enhanced.

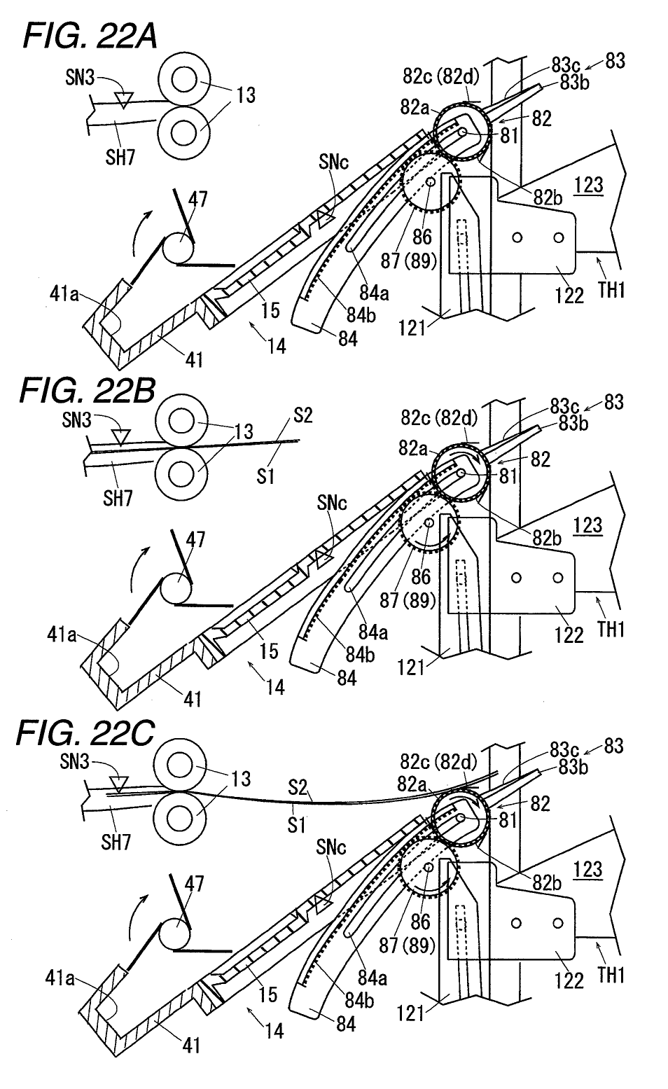

FIGS. 22A, 22B and 22C are views illustrating the function of the thus configured post-processing apparatus of Example 1, FIG. 22A is a view showing a state where the end-stitching process and the sheet discharging process are executed and no sheet is discharged on the compile tray (a state where the compile tray is empty), FIG. 22B is a view showing the initial state of the sheet introducing process in which the first and second recording sheets are introduced in an overlapping manner to the empty compile tray, and FIG. 22C is a view showing a state immediately before the end of the sheet introducing process.

Referring to FIG. 22A, the shelves 84 are moved to the housed position, and the set clamp paddles 83 are moved to the sheet lower face supporting position. Moreover, the stacker tray discharging roller driving motor M4 (see FIG. 17) is stopped, and the electromagnetic clutch CL0 (see FIG. 17) is turned off. Therefore, also the driving shaft 86 and the discharging roller shaft 81 of FIG. 22A are stopped.

Referring to FIG. 22B, when the first and second recording sheets S1, S2 are conveyed to the end-stitching discharging path SH7 and the compile tray sheet discharge sensor SN3 detects the front end of the sheet (see ST131 to ST133 of FIG. 20), the driving shaft 86 and the discharging roller driving gears 87 are forwardly rotated (rotated in the direction of the arrow in FIG. 22B) (see ST135 of FIG. 20).

At this time, also the shelf operating gears 89 attached to the driving shaft 86 via the torque limiters 88 try to be rotated, but the rack gears 84b meshing with the shelf operating-gears 89 are not moved. Therefore, the shelf operating gears are not rotated. The driving shaft 86 is idly rotated with respect to the shelf operating gears 89. In accordance with the rotation of the discharging roller driving gears 87, the discharging rollers 82 which are rotated integrally with the discharging roller driving gears 87 are rotated in the discharging direction (the direction of the arrow in FIG. 22B).

Referring to FIG. 22C, when the front end portions of the first and second recording sheets S1, S2 discharged to the compile tray 14 are in contact with the upper face of the compile tray 14, the front end portions of the sheets S are conveyed to the upper faces of the set clamp paddles 83 by the forward rotation of the discharging rollers 82.

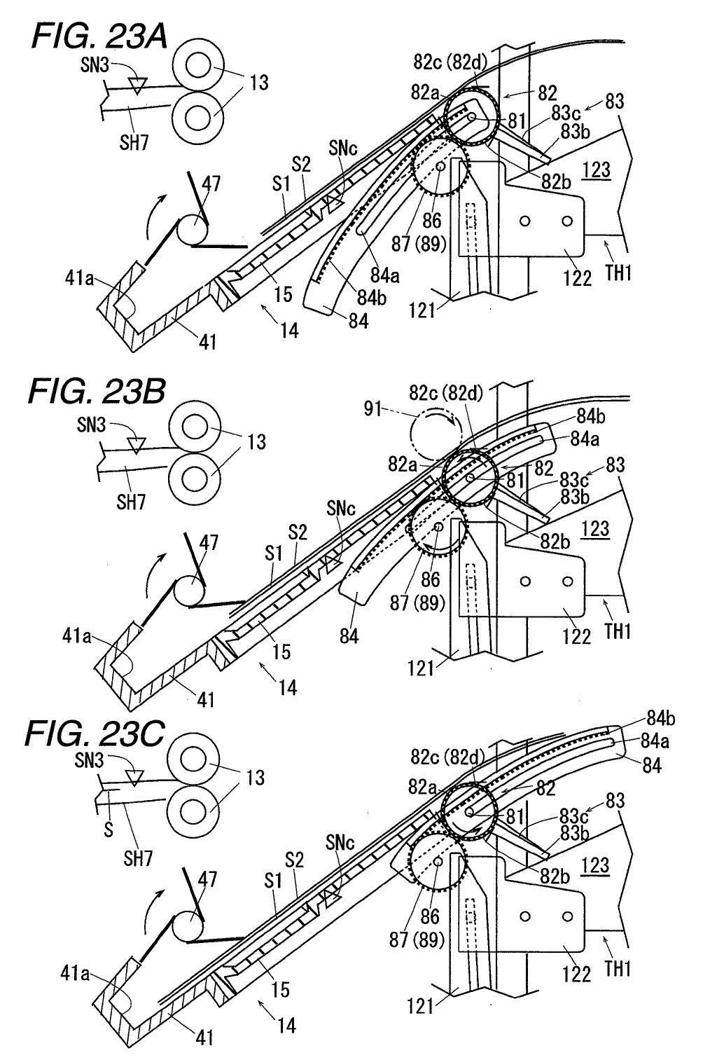

Immediately before the introduction of the first and second recording sheets S1, S2 to the compile tray 14 is completed (i.e., immediately before the forward rotation of the discharging rollers 82 is stopped), the electromagnetic clutch CL0 is turned on, and the set clamp paddles 83 are swung from the sheet lower face supporting position shown in FIG. 22C to the clamping position (see FIGS. 23A, 23B and 23C which will be described later) where the paddles press the sheet of the upper face of the stacker tray TH1 (see ST136 to ST139 of FIG. 20).

FIGS. 23A, 23B and 23C are views illustrating the function of the thus configured post-processing apparatus of Example 1, FIG. 23A is a view showing a state immediately after the sheet introducing process is ended (a state immediately after the first and second recording sheets S1, S2 are discharged to the compile tray), FIG. 23B is a view showing the initial state of the rear-end aligning process, and FIG. 23C is a view showing a state immediately before the end of the rear-end aligning process.

Referring to FIG. 23A, the shelves 84 remain to be moved to the housed position, and the set clamp paddles 83 are moved to the clamping position. The first and second recording sheets S1, S2 are in a state where the sheet introducing process is ended, i.e., a state where the sheets are stacked on the compile tray 14. At this time, the stacker tray discharging roller driving motor M4 is temporarily stopped (see ST141 of FIG. 20).

Referring to FIG. 23B, the clamp rollers 91 are moved to the clamping position where the rollers press the upper face of the second recording sheet S2 discharged to the compile tray 14 (see (1) of ST143 of FIG. 20). The discharging roller driving motor M4 is reversely rotated in a state where the clamp rollers 91 are moved from the waiting position (see the solid line in FIG. 2) to the clamping position (see the dash-dot line in FIG. 3) (see (2) of ST143 of FIG. 20). At this time, the front end portions of the first and second recording sheets S1, S2 which are clamped by the clamp rollers 91 and the discharging rollers 82 are conveyed toward the rear-end positioning wall 41a of the sheet rear-end positioning member 41. Furthermore, the shelves 84 are moved from the housed position (see FIG. 23B) toward the sheet lower face supporting position (see FIG. 23C).

Referring to FIG. 23C, when the rear ends of the first and second recording sheets S1, S2 are conveyed to a position where the sheets can be conveyed by the main paddles 47 (see ST144 of FIG. 20), the clamp rollers 91 are moved from the clamping position to a retracted position (see ST145 of FIG. 20).

In the post-processing apparatus U4 of Example 1, in the state of FIG. 23C, the main paddles 47 continue to be rotated, and contacted with the upper face of the second recording sheet S2 to convey the rear end of the second recording sheet S2 to the rear-end positioning wall 41a, and also the discharging rollers 82 continue to be reversely rotated, and contacted with the lower face of the first recording sheet S1 to convey the rear end of the first recording sheet S1 to the rear-end positioning wall 41a (see ST146 and ST147 of FIG. 20). Even when the first and second recording sheets S1, S2 in a state where the two sheets overlap each other are introduced, therefore, both the recording sheets S1, S2 can be surely butted against the rear-end positioning wall 41a, and hence misalignment in the rear end of the bundle of the recording sheets S can be reduced.

Referring to FIG. 23C, the discharging rollers 82 in Example 1 have the lower sheet conveying vanes 82c, 82d. In the case where the rear end of the first recording sheet S5 is conveyed to the rear-end positioning wall 41a, when the lower face of the first recording sheet S1 abuts against the lower sheet conveying vanes 82c, 82d, a state is formed where the lower sheet conveying vanes 82c, 82d are pressed in the downward direction (−Z direction) by the weight of the first recording sheet S1 (and the second recording sheet S2) to be in a flexed state. As a result, the lower sheet conveying vanes 82c, 82d are pressed against the lower face of the first recording sheet S1 at a predetermined force by the elastic resilient forces of the flexed lower sheet conveying vanes 82c, 82d. When the discharging rollers 82 are rotated, therefore, a conveying force can be surely applied.

The lower sheet conveying vanes 82c, 82d extend in a tangential direction of the outer circumferential faces of the discharging rollers 82. In the case where the lower sheet conveying vanes 82c, 82d abut against the lower face of the first recording sheet S1 to be pressed and flexed by the first recording sheet S1 (and the second recording sheet S2), therefore, the area where the lower sheet conveying vanes 82c, 82d are contacted with the first recording sheet S1 can be increased as compared with the case where the lower sheet conveying vanes 82c, 82d radially extend. Therefore, the lower sheet conveying vanes 82c, 82d can surely apply a conveying force to the first recording sheet S1 as compared with the case where the lower sheet conveying vanes 82c, 82d radially extend. Even when the lower sheet conveying vanes 82c, 82d are short in length, a conveying force can be surely applied to the first recording sheet S1. For example, the lengths of the lower sheet conveying vanes 82c, 82d may be set to 1.5 mm.

In the case where the first recording sheet S1 (and the second recording sheet S2) is stacked and flexed, the lower sheet conveying vanes 82c, 82d are deformed so as to twine around the discharging roller bodies 82a, so that the step differences between the discharging roller bodies 82a and the lower sheet conveying vanes 82c, 82d are reduced, as compared with the case where the lower sheet conveying vanes radially extend. Moreover, the lower sheet conveying vanes 82c, 82d are placed with avoiding the range where the first recording sheet S1 is clamped by the discharging roller bodies 82a and the clamp rollers 91, i.e., the middle portions of the discharging roller bodies 82a, 82b. In the case where the discharging roller bodies 82a and the clamp rollers 91 convey the recording sheet S while claming the sheet, therefore, phenomena that the recording sheet S wrinkles, and that the lower sheet conveying vanes 82c, 82d are bent to be damaged can be reduced.

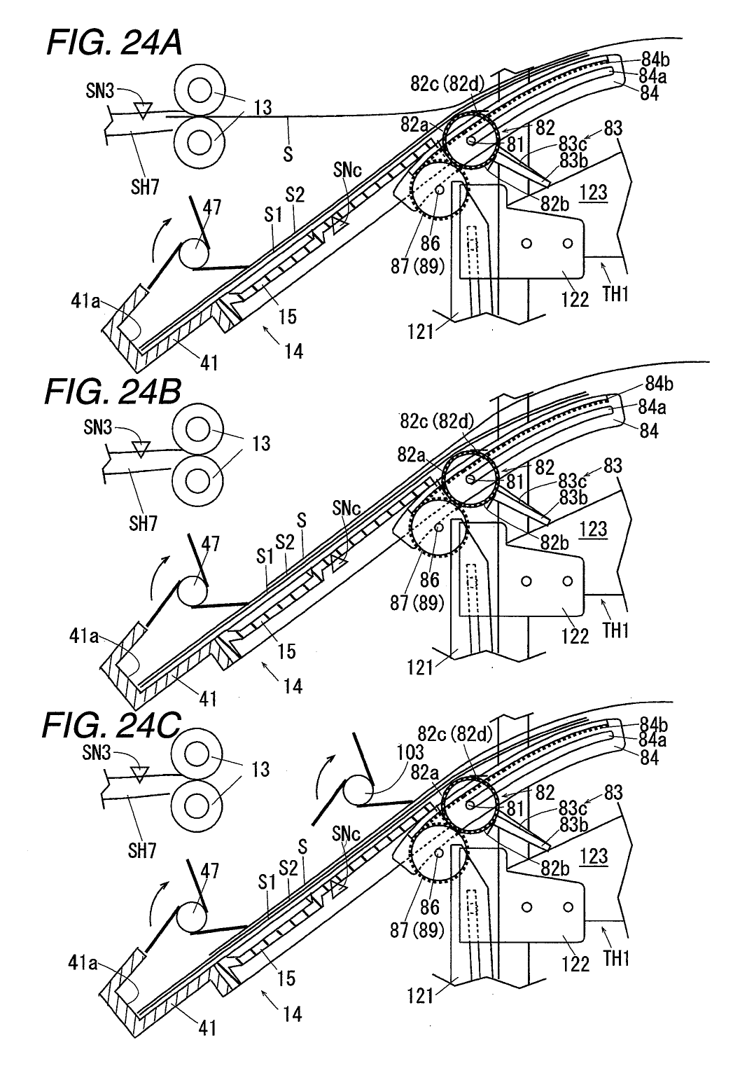

When, in the state of FIG. 23C, the rear ends of the first and second recording sheets S1, S2 are butted against the rear-end positioning wall 41a (see FIG. 24A) and the shelves 84 are moved to the sheet lower face supporting position (see ST146 of FIG. 20), the discharging roller driving motor M4 is stopped, and also the driving shaft 86, the discharging roller driving gears 87, and the shelf operating gears 89 are stopped (see ST147 of FIG. 20). Even when a second or subsequent sheet is thereafter discharged on the first sheet on the compile tray 14, the stacker tray discharging roller driving motor M4, the driving shaft 86, the discharging roller driving gears 87, and the shelf operating gears 89 remain to be stopped, and are not rotated. When a third or subsequent sheet is discharged to the compile tray 14, however, the discharged sheet S is conveyed by the sub-paddles 103 (see FIG. 3) toward the sheet rear-end positioning member 41 (see ST148 to ST150 of FIG. 20).

FIGS. 24A, 24B and 24C are views illustrating the rear-end aligning process in the case where the third recording sheet is discharged to the compile tray, FIG. 24A is a view showing a state where the third recording sheet is discharged to the compile tray, FIG. 24B is a view showing a state where a third sheet has been discharged to the compile tray, and FIG. 24C is a view showing a state where the third sheet is conveyed toward the sheet rear-end positioning member.

Referring to FIG. 24A, the third recording sheet S is discharged to the compile tray 14. When the third or subsequent sheet is discharged to the compile tray 14, the driving shaft 86, the discharging roller driving gears 87, and the shelf operating gears 89 remain to be stopped.

In the state where the third recording sheet S is discharged onto the second recording sheet S2 on the compile tray 14 (see FIG. 24B), the sub-paddles 103 are contacted with the upper face of the third recording sheet S to convey the third recording sheet S toward the sheet rear-end positioning member 41 (see ST148 to ST150 of FIG. 20, and FIG. 24C).

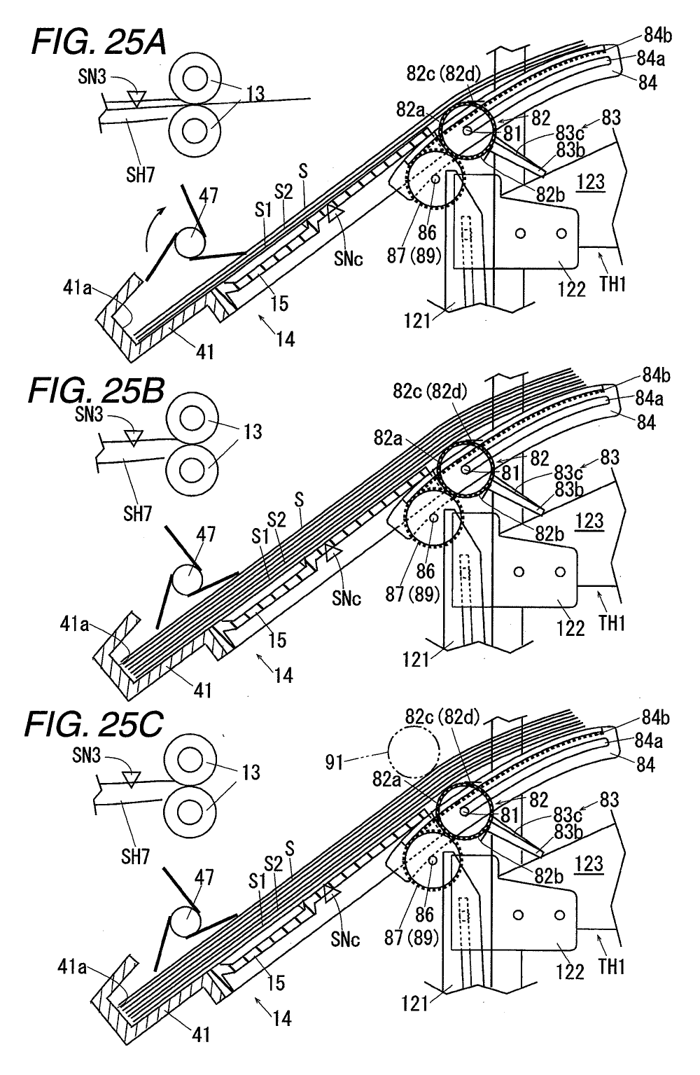

FIGS. 25A, 25B and 25C are views illustrating a state where a fourth sheet is discharged to the compile tray and the rear end of the sheet is conveyed to the sheet rear-end positioning member, and a fourth or subsequent sheet is discharged, FIG. 25A is a view showing a state where the fourth recording sheet is discharged to the compile tray, FIG. 25B is a view showing a state where an end-stitching process execution number of sheets have been discharged to the compile tray and discharged to the sheet rear-end positioning member, and FIG. 25C is a view showing a state where the clamp rollers are contacted with the upper face of the end-stitching process execution number of sheets of FIG. 25B.

Referring to FIG. 25A, the fourth sheet S is discharged to the compile tray 14. In the case where a fourth or subsequent recording sheet S is discharged to the compile tray 14, similarly with the above-described case of the third recording sheet S, the sheet is conveyed toward the sheet rear-end positioning member 41 by the sub-paddles 103 (see FIGS. 3 and 24C), and aligned (see ST148 to ST150 of FIG. 20).

Referring to FIG. 25B, in a state where the end-stitching process execution number Na of recording sheets S are discharged to the compile tray 14 (see ST109 of FIG. 19) and discharged to the sheet rear-end positioning member, the rotation of the main paddles 47 is stopped (see ST110 of FIG. 19).

In the case where, in the state of FIG. 25B, the stapling process set by the input from the user through the post-processing setting key UI5 is “corner stitching” or “side end-stitching”, the movable staple member 70 is moved to the stitching position, i.e., the home position (the reference position and the corner stitching position, see the dash-dot line in FIG. 6) and the staple positions (side end-stitching positions, see the solid line or the dash-dot-dot line in FIG. 6), and the staple needle 77 is punched out from the needle punching portion 76a of the movable staple member 70, thereby stitching the bundle of the recording sheets S (see ST21 of FIG. 19).

Referring to FIG. 25C, the clamp rollers 91 are moved to the clamping position where the clamp rollers are contacted with the upper face of the bundle of the end-stitching process execution number Na of recording sheets S of FIG. 25B (see (1) of ST151 of FIG. 21).

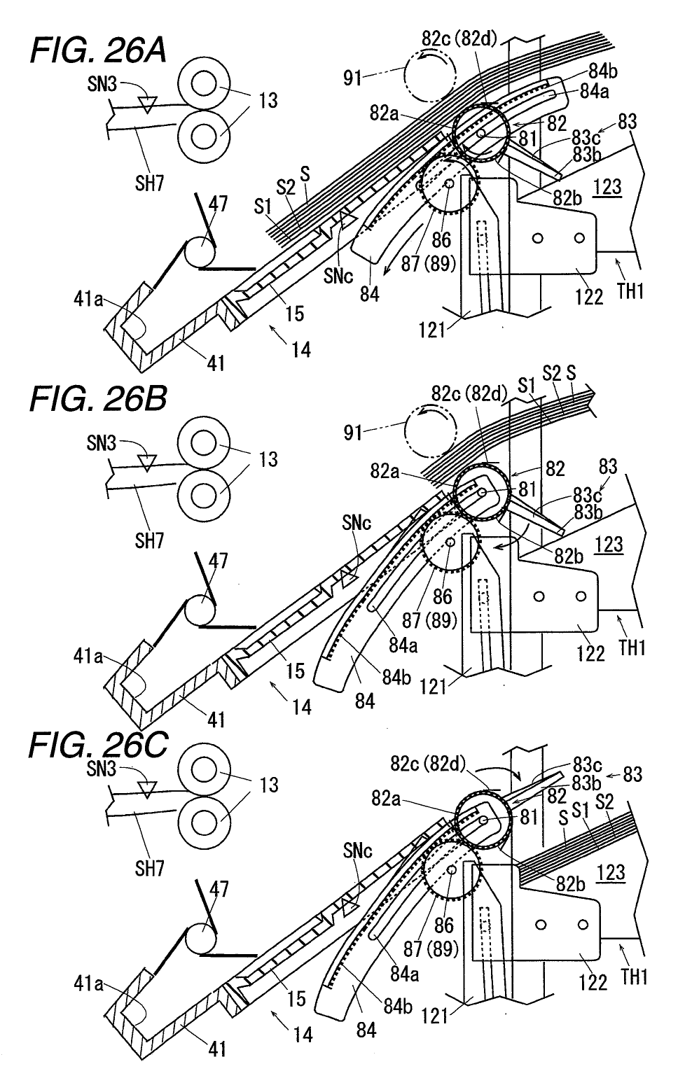

FIGS. 26A, 26B and 26C are views illustrating the sheet discharging process in Example 1, and operations of the discharging rollers, the shelves, the set clamp paddles, and the like in the case where the end-stitching process execution number of recording sheets housed in the compile tray in the stacked state are discharged to the stacker tray, FIG. 26A is a view showing a state in the course where the end-stitching process execution number of recording sheets are discharged to the stacker tray by rotating the discharging rollers in the state of FIG. 25C, FIG. 26B is a view showing a state immediately before the discharging of the end-stitching process execution number of recording sheets to the stacker tray is ended, and FIG. 26C is a view showing a state where the discharging of the end-stitching process execution number of recording sheets to the stacker tray is ended.

In FIG. 26A, the main paddles 47 are stopped (see ST110 of FIG. 19). When the driving shaft 86, the discharging roller driving gears 87, and the shelf operating gears 89 are forwardly rotated, the end-stitching process execution number Na of recording sheets (bundle-like recording sheets) S which are clamped by the clamp rollers 91 and the discharging rollers 82 are conveyed toward the stacker tray TH1 (see (2) of ST151 of FIG. 21). At this time, the shelves 84 are moved from the sheet lower face supporting position (see FIG. 25C) toward the housed position (see FIG. 26B).

Immediately before the discharging of the bundle-like recording sheets S to the stacker tray TH1 is completed (see FIG. 26B), the electromagnetic clutch CL0 (see FIG. 17) is turned on, and the set clamp paddles 83 start to swing in a clockwise direction from the clamping position (the position shown in FIG. 26B) toward the sheet lower face supporting position (see FIG. 26C) (see ST152 and ST153 of FIG. 21). At the same time with the completion (see FIG. 23C) of discharging of the bundle-like sheets S to the stacker tray TH1, the paddles are swung to the sheet lower face supporting position (see FIG. 13) (see ST154 to ST156 of FIG. 21). Then, the clamp rollers 91 are moved from the clamping position to the retracted position (see (1) of ST157 of FIG. 21), and the rotation of the discharging rollers 82 is stopped (see (1) of ST157 of FIG. 21), thereby ending the sheet discharging process.

### (Modifications)

Although, in the above, the examples of the invention have been described in detail, the invention is not restricted to the examples. Various modifications are enabled within the scope of the spirit of the invention set forth in the claims. Modifications (H01) to (H05) of the invention will be exemplified.
(H01) The invention may be applied to an image forming apparatus such as a copier, a printer, a FAX, and a multi-function machine, and a post-processing device.
(H02) The configuration in which the discharging roller rotating driving shaft is rotated forwardly or reversely by the stacker tray discharging roller driving motor may employ a configuration in which a stacker tray discharging roller driving motor is rotated forwardly or reversely, that in which a stacker tray discharging roller driving motor that is rotated only in the forward direction is used, two gear trains or a forward-rotation gear train and a reverse-rotation gear train are disposed between the motor and the discharging roller rotating driving shaft, and clutches disposed in the gear trains are on/off controlled, or another configuration.
(H03) In the examples, the case where the lower sheet conveying vanes 82c, 82d have a length of 1.5 mm is exemplified. The vanes can be set to have an arbitrary length. For example, preferably, the lengths of the lower sheet conveying vanes 82c, 82d are 2.0 mm or less. Even in the case of a length of about 0.5 mm, it is possible to surely apply a conveying force to the first recording sheet S1. The three lower sheet conveying vanes 82c, 82d are fixedly supported at regular intervals (intervals of 120°) along the circumferential direction. The number of the vanes is not restricted to three. An arbitrary number of vanes may be added or reduced. The lower sheet conveying vanes 82c, 82d are not restricted to the configuration where the vanes are separately formed and supported by the discharging roller body 82a, and may be formed integrally with the discharging roller body 82a. In the invention, the lower sheet conveying vanes 82c, 82d may be omitted from the discharging rollers 82. The first recording sheet S1 may be butted against the rear-end positioning wall 41a with using only the conveying force exerted by the discharging rollers 82.
(H04) In the examples, the sheet waiting path SH7c is connected to the end-stitching discharging path SH7. The invention is not restricted to this. The sheet waiting path may be connected to any position as far as it is upstream from the compile tray 14. For example, the sheet waiting path SH7c may be connected to a position between the sheet introducing port 1 and the switching gates 2, 3. In this case, the sheet waiting process may be applied also to the saddle stitching device NTS.
(H05) The post-processing apparatus U4 of Example 1 has the saddle stitching device NTS. Alternatively, the saddle stitching device may be omitted.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A post-processing apparatus comprising:
a compile tray which comprises an one-end aligning portion that aligns one end edge of a bundle of recording media, and on which image-recorded recording media are to be stacked;
a post-processing member which performs a post processing on recording media stacked on the compile tray;
a stacker tray to which a bundle of recording media that the post processing is performed is discharged and stacked;
a sheet conveying path comprising: a discharging path through which the recording medium is discharged to the compile tray; a waiting path which is connected to the discharging path, and in which the recording medium to be discharged to the compile tray waits; and a discharging-path switching member which switches whether the recording medium is conveyed from the discharging path to the waiting path or not;
a sheet conveying member which is placed in the discharging path, which discharges the recording medium to the compile tray, and which can discharge a recording medium waiting in the waiting path and a recording medium conveyed through the discharging path, to the compile tray while overlapping the recording media;
a one-end alignment medium conveying member which is in contact with one face side of the bundle of recording media stacked on the compile tray, and which butts the conveyed recording media against the one-end aligning portion to align the conveyed recording medium;
a discharging member which is in contact with another face side of the bundle of recording media stacked on the compile tray, and which discharges the bundle to the stacker tray; and
a discharging-member controlling section which, when the post processing is performed on the bundle of recording media, drives the discharging member to discharge the bundle to the stacker tray, and which, when the recording media in an overlapped state are conveyed to the compile tray, drives the discharging member in reverse rotation to butt the recording medium on the other face side against the one-end aligning portion to align the recording medium.

2. The post-processing apparatus according to claim 1, wherein the apparatus further comprises a clamping member that is placed opposed to the discharging member, and that is supported to be movable between a clamping position in which the clamping member clamps recording media on the compile tray, and a separate position which is separated from the discharging member.

3. The post-processing apparatus according to claim 1, wherein the post-processing member is configured by a tamper which aligns side edges of the recording media.

4. The post-processing apparatus according to claim 2, wherein the post-processing member is configured by a tamper which aligns side edges of the recording media.

5. The post-processing apparatus according to claim 1, wherein the post-processing member is configured by a stapler which stitches the recording media.

6. The post-processing apparatus according to claim 2, wherein the post-processing member is configured by a stapler which stitches the recording media.

7. The post-processing apparatus according to claim 3, wherein the post-processing member is configured by a stapler which stitches the recording media.

8. The post-processing apparatus according to claim 4, wherein the post-processing member is configured by a stapler which stitches the recording media.

9. The post-processing apparatus according to claim 1, wherein the apparatus further comprises a discharging-path switch controlling section which, when the recording medium is conveyed through the discharging path during execution of the post processing by the post-processing member, controls the discharging-path switching member to convey the recording medium to the waiting path, thereby causing the recording medium to wait.

10. The post-processing apparatus according to claim 2, wherein the apparatus further comprises a discharging-path switch controlling section which, when the recording medium is conveyed through the discharging path during execution of the post processing by the post-processing member, controls the discharging-path switching member to convey the recording medium to the waiting path, thereby causing the recording medium to wait.

11. The post-processing apparatus according to claim 3, wherein the apparatus further comprises a discharging-path switch controlling section which, when the recording medium is conveyed through the discharging path during execution of the post processing by the post-processing member, controls the discharging-path switching member to convey the recording medium to the waiting path, thereby causing the recording medium to wait.

12. The post-processing apparatus according to claim 4, wherein the apparatus further comprises a discharging-path switch controlling section which, when the recording medium is conveyed through the discharging path during execution of the post processing by the post-processing member, controls the discharging-path switching member to convey the recording medium to the waiting path, thereby causing the recording medium to wait.

13. The post-processing apparatus according to claim 5, wherein the apparatus further comprises a discharging-path switch controlling section which, when the recording medium is conveyed through the discharging path during execution of the post processing by the post-processing member, controls the discharging-path switching member to convey the recording medium to the waiting path, thereby causing the recording medium to wait.

14. The post-processing apparatus according to claim 6, wherein the apparatus further comprises a discharging-path switch controlling section which, when the recording medium is conveyed through the discharging path during execution of the post processing by the post-processing member, controls the discharging-path switching member to convey the recording medium to the waiting path, thereby causing the recording medium to wait.

15. The post-processing apparatus according to claim 7, wherein the apparatus further comprises a discharging-path switch controlling section which, when the recording medium is conveyed through the discharging path during execution of the post processing by the post-processing member, controls the discharging-path switching member to convey the recording medium to the waiting path, thereby causing the recording medium to wait.

16. The post-processing apparatus according to claim 8, wherein the apparatus further comprises a discharging-path switch controlling section which, when the recording medium is conveyed through the discharging path during execution of the post processing by the post-processing member, controls the discharging-path switching member to convey the recording medium to the waiting path, thereby causing the recording medium to wait.
